(19) United States
(12) Patent Application Publication
(10) Pub. No.: US 2026/0253603 A1
(43) Pub. Date: Aug. 27, 2026

(54) SYSTEM

(71) Applicant: SoftBank Group Corp., Tokyo (JP)

(72) Inventor: Hiroki KANI, Tokyo (JP)

(73) Assignee: SoftBank Group Corp., Tokyo (JP)

(21) Appl. No.: 19/534,754

(22) Filed: Feb. 10, 2026

(30) Foreign Application Priority Data
Feb. 21, 2025 (JP) 2025-027064

(51) Int. Cl. G10L 25/63

(52) U.S. Cl. CPC G10L 25/63

(57) ABSTRACT

The system according to the embodiment comprises a collection unit, an analysis unit, a detection unit, a conversation unit, and a notification unit. The collection unit collects voice data. The analysis unit analyzes the voice data collected by the collection unit. The detection unit detects an abnormality based on data analyzed by the analysis unit. The conversation unit converses with a user when an abnormality is detected by the detection unit. The notification unit notifies a family of the abnormality confirmed by the conversation unit.

### CROSS-REFERENCE TO RELATED APPLICATION

The present application claims priority to and incorporates by reference the entire contents of Japanese Patent Application No. 2025-027064 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, measures against remittance fraud and solitary death have not been sufficiently implemented, and there is room for improvement.

### SUMMARY OF THE INVENTION

The system according to the embodiment comprises a collection unit, an analysis unit, a detection unit, a conversation unit, and a notification unit. The collection unit collects voice data. The analysis unit analyzes the voice data collected by the collection unit. The detection unit detects an abnormality based on data analyzed by the analysis unit. The conversation unit converses with a user when an abnormality is detected by the detection unit. The notification unit notifies a family of the abnormality confirmed by the conversation unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

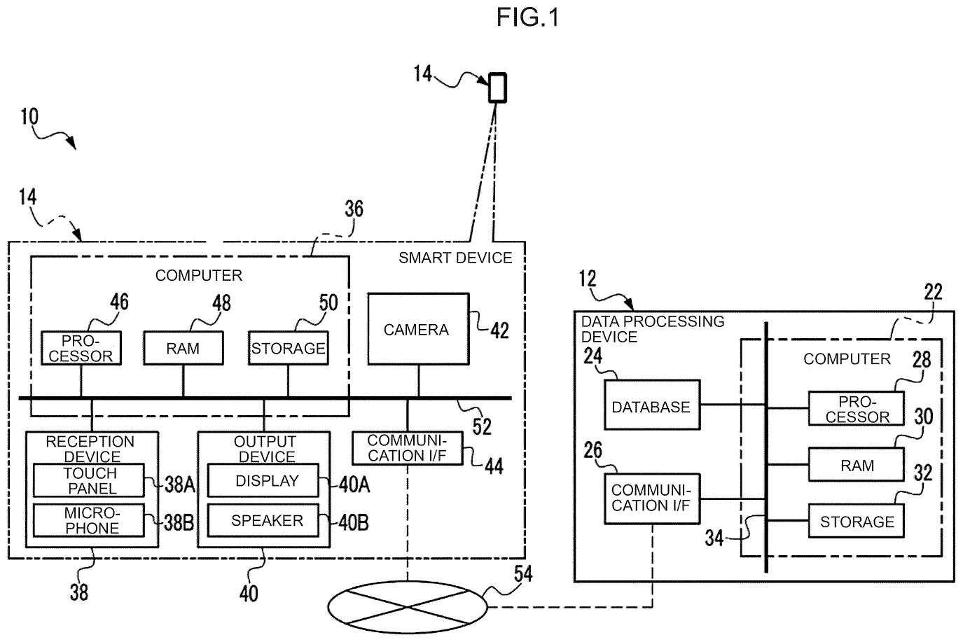

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

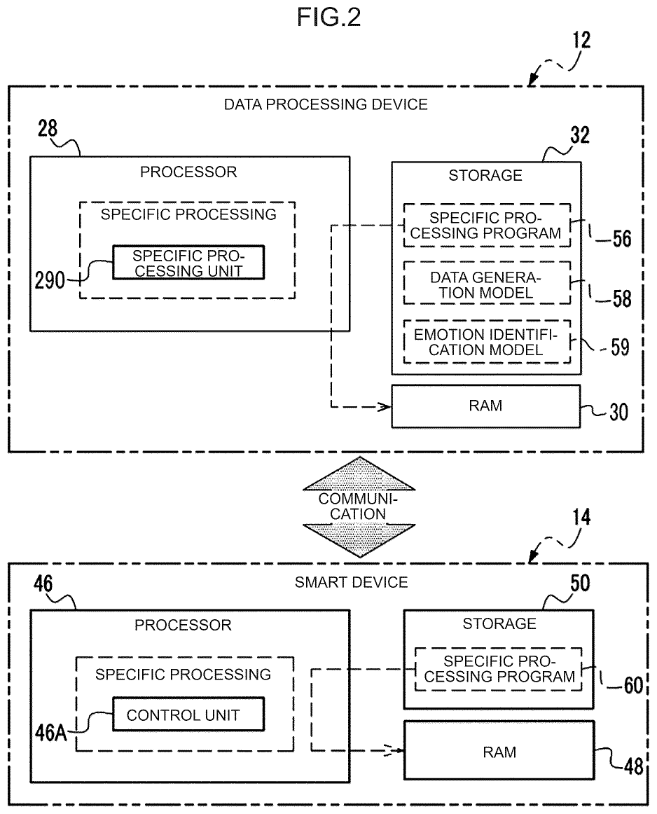

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The system according to the embodiment of the present invention is a system that utilizes an unused smartphone to sense sounds in a room and detect abnormalities from conversations and sounds in the room. This system first constantly senses sounds in the room using the smartphone. Next, AI analyzes the sensed voice data and detects abnormal sounds or conversations. For example, this includes cases where a fraudulent phone call (such as a remittance scam) is received, or abnormal sounds occur in the room (such as the sound of an object falling or a call for help). When an abnormality is detected, the AI attempts to converse with the user and confirm the situation. If necessary, the AI sends a notification to the family to inform them of the abnormality. With this system, it is possible to prevent damage from remittance scams in advance and reduce the risk of solitary death. For example, when an elderly person lives alone, the smartphone constantly monitors the sounds in the room, enabling a prompt response when an abnormality occurs. Furthermore, by having the AI send notifications to the family, the family can live with peace of mind. In this way, abnormalities can be detected quickly and appropriate responses can be taken. Specifically, the system uses the built-in microphone of a smartphone terminal to collect indoor voice in real time at a sampling rate such as 16 kHz or 48 kHz, and the collected voice data is framed at regular intervals (for example, as a 1D tensor of 16,000 samples every second) and input to the AI analysis module. The AI analysis module uses a convolutional neural network (CNN) and a Transformer-type voice classification model equipped with self-attention mechanisms to extract features such as Mel spectrograms from the input voice tensor and identify abnormal sounds (e.g., loud impact sounds, calls for help, characteristic conversation patterns of scam calls). Examples of input to the AI include (1) “1D voice waveform tensor of 16,000 samples”, (2) “Mel spectrogram image of 128 dimensions×100 frames”, and (3) “text sequence extracted by a speech recognition engine”. The output of the AI includes (1) abnormal sound labels (e.g., normal, crash, help, scam_call), (2) abnormality score (continuous value from 0.0 to 1.0), and (3) timestamp information of the abnormal occurrence section, such as “crash, 0.92, 12:03:15-12:03:17” or “scam_call, 0.85, 12:10:05-12:10:30”. The AI model is trained on a large dataset of normal and abnormal sounds using supervised learning, optimized with loss functions such as cross-entropy or Focal Loss. After abnormality detection, the system uses a natural language generation AI (large language model) to initiate a conversation with the user, generating questions such as “Is something troubling you right now?” and analyzing the user's response voice with speech recognition and emotion analysis AI. The content of the user's response and emotional state (e.g., anxiety, fear, confusion) are estimated, and if the situation is judged to be urgent, the notification module automatically sends an abnormality notification to the family's smartphone or email address. The notification content is generated as structured data including the type of abnormality, occurrence time, and estimated user situation. As a technical effect, the system achieves high-precision abnormality detection and automatic notification by AI without relying on constant human monitoring or manual reporting, simultaneously achieving real-time performance, accuracy, privacy protection, and reduction of false alarms, which were difficult with conventional human operations. In addition, continuous learning of the AI model and automatic updating of abnormal patterns enable flexible adaptation to environmental changes and new scam methods. Application fields include elderly monitoring, safety management for people living alone, fraud prevention, support for people with disabilities, abnormality monitoring in nursing facilities, and safety management in home medical care. With these technical configurations and effects, the present invention not only automates human tasks but also contributes to the advancement of computer technology itself and the resolution of social issues.

The abnormality detection system according to the embodiment comprises a collection unit, an analysis unit, a detection unit, a conversation unit, and a notification unit. The collection unit collects voice data. For example, the collection unit constantly senses sounds in a room. The collection unit may also collect voice data using AI. The analysis unit analyzes the voice data collected by the collection unit. For example, the analysis unit analyzes the sensed voice data and detects abnormal sounds or conversations. The analysis unit analyzes voice data using AI. The detection unit detects an abnormality based on data analyzed by the analysis unit. For example, the detection unit detects an abnormality based on the analyzed data. The detection unit detects abnormalities using AI. The conversation unit attempts to converse with the user and confirm the situation when an abnormality is detected. For example, the conversation unit attempts to converse with the user and confirm the situation when an abnormality is detected. The conversation unit attempts to converse with the user using AI. The notification unit notifies a family of the abnormality confirmed by the conversation unit. For example, the notification unit notifies a family of the confirmed abnormality. The notification unit may also notify a family using AI. Thus, the abnormality detection system according to the embodiment can reduce the risk of remittance scams and solitary death by performing processes of collecting, analyzing, detecting abnormalities, conversing, and notifying with respect to voice data. Specifically, the abnormality detection system uses the built-in microphone of a smartphone terminal or a stationary IoT device to collect indoor voice in real time at a high sampling rate such as 16 kHz or 48 kHz. The collection unit frames the voice waveform data at regular intervals and transfers it to the AI analysis module, for example, as a 1D tensor of 16,000 samples every second. The AI analysis module implements a convolutional neural network (CNN) and a Transformer-type voice classification model equipped with self-attention mechanisms, extracting features such as Mel spectrograms and MFCC from the input voice tensor. The analysis unit uses the extracted features to identify abnormal sounds (e.g., loud impact sounds, calls for help, characteristic conversation patterns of scam calls) and abnormal conversations. Examples of input to the AI include (1) 1D voice waveform tensor of 16,000 samples, (2) Mel spectrogram image of 128 dimensions×100 frames, and (3) text sequence extracted by a speech recognition engine. The output of the AI includes (1) abnormal sound labels (e.g., normal, crash, help, scam_call), (2) abnormality score (continuous value from 0.0 to 1.0), and (3) timestamp information of the abnormal occurrence section, such as “crash, 0.92, 12:03:15-12:03:17” or “scam_call, 0.85, 12:10:05-12:10:30”. The detection unit receives abnormal labels and scores from the analysis unit, performs threshold judgment and rule-based branching processing, and determines the presence and type of abnormality. The conversation unit, when an abnormality is detected, uses a large language model to initiate a conversation with the user, generating questions such as “Is something troubling you right now?” and analyzing the user's response voice with speech recognition and emotion analysis AI. The content of the user's response and emotional state (e.g., anxiety, fear, confusion) are estimated, and if the situation is judged to be urgent, the notification unit automatically sends an abnormality notification to the family's smartphone or email address. The notification content is generated as structured data including the type of abnormality, occurrence time, and estimated user situation. The AI model is trained on a large dataset of normal and abnormal sounds using supervised learning, optimized with loss functions such as cross-entropy or Focal Loss. As a technical effect, the system achieves high-precision abnormality detection and automatic notification by AI without relying on constant human monitoring or manual reporting, simultaneously achieving real-time performance, accuracy, privacy protection, and reduction of false alarms, which were difficult with conventional human operations. In addition, continuous learning of the AI model and automatic updating of abnormal patterns enable flexible adaptation to environmental changes and new scam methods. Application fields include elderly monitoring, safety management for people living alone, fraud prevention, support for people with disabilities, abnormality monitoring in nursing facilities, and safety management in home medical care. With these technical configurations and effects, the present invention not only automates human tasks but also contributes to the advancement of computer technology itself and the resolution of social issues.

The collection unit can constantly sense sounds in a room. For example, the collection unit constantly senses sounds in a room. Constant sensing may be performed using a microphone, for example. The collection unit may also collect voice data using AI. By constantly sensing sounds in a room, abnormalities can be detected early. Specifically, the collection unit uses the built-in microphone of a smartphone or stationary IoT device to acquire indoor voice in real time at a high sampling rate such as 16 kHz or 48 kHz. The collection unit frames the voice waveform data at regular intervals and transfers it to the AI analysis module, for example, as a 1D tensor of 16,000 samples every second. When using AI, the collection unit automatically performs preprocessing such as noise removal, source separation, and volume normalization on the voice signal, shaping the data into a form that is easy for the AI model to analyze. Examples of input to the AI include (1) 1D voice waveform tensor of 16,000 samples, and (2) Mel spectrogram image of 128 dimensions×100 frames. The output of the AI includes (1) abnormality score for each voice segment, and (2) abnormal sound candidate labels with timestamps. These outputs are used by subsequent analysis and detection units for threshold judgment and classification of abnormal types. As a technical effect, by combining constant sensing and AI-based preprocessing, the collection unit achieves real-time performance, high accuracy, and reduction of false alarms, which are difficult with manual human monitoring, contributing to early detection of abnormalities and privacy protection. Application fields include elderly monitoring, safety management for people living alone, fraud prevention, and abnormality monitoring in nursing facilities.

The analysis unit can analyze the sensed voice data and detect abnormal sounds or conversations. For example, the analysis unit analyzes the sensed voice data and detects abnormal sounds or conversations. Abnormal sounds or conversations include, for example, fraudulent phone calls, the sound of objects falling, and calls for help. The analysis unit analyzes voice data using AI. By detecting abnormal sounds or conversations, fraudulent activities and abnormal situations can be discovered early. Specifically, the analysis unit implements a convolutional neural network (CNN) and a Transformer-type voice classification model equipped with self-attention mechanisms, receiving voice tensors and Mel spectrograms from the collection unit as input. Examples of input to the AI include (1) 1D voice waveform tensor of 16,000 samples, (2) Mel spectrogram image of 128 dimensions×100 frames, and (3) text sequence extracted by a speech recognition engine. The analysis unit extracts acoustic features (e.g., zero-crossing rate, spectral flatness, MFCC) and linguistic features (e.g., phrases characteristic of scam calls, patterns of calls for help) from these inputs and determines the presence of abnormal sounds or conversations. The output of the AI includes (1) abnormal sound labels (e.g., crash, help, scam_call), (2) abnormality score (0.0-1.0), and (3) timestamp information of the abnormal occurrence section, such as “scam_call, 0.85, 12:10:05-12:10:30”. The analysis unit passes these outputs to the detection unit for subsequent abnormality judgment and notification processing. The AI model is trained on a large dataset of normal and abnormal sounds using supervised learning, optimized with loss functions such as cross-entropy or Focal Loss. As a technical effect, by performing high-dimensional feature extraction and pattern recognition with AI, the analysis unit achieves high-precision detection of abnormal sounds and conversations, which are difficult for human hearing or simple rule-based processing, contributing to reduction of false alarms and improvement of real-time performance. Application fields include fraud prevention, reduction of solitary death risk, and abnormality monitoring in nursing facilities.

The detection unit can detect an abnormality based on analyzed data. For example, the detection unit detects an abnormality based on the analyzed data. Abnormalities include, for example, fraudulent phone calls, the sound of objects falling, and calls for help. The detection unit detects abnormalities using AI. By detecting abnormalities based on analyzed data, abnormal situations can be quickly grasped. Specifically, the detection unit receives abnormal sound labels, abnormality scores, and timestamp information from the analysis unit as input and performs threshold judgment and rule-based branching processing. Examples of input to the AI include (1) abnormal sound labels (e.g., crash, help, scam_call), (2) abnormality score (0.0-1.0), and (3) timestamp information of the abnormal occurrence section. The detection unit determines the occurrence of an abnormality when the abnormality score exceeds a predetermined threshold (e.g., 0.8) and decides the priority and notification method for each type of abnormality. When using AI, the detection unit also performs time-series analysis of abnormal patterns and integrated analysis of multiple sensor information to reduce false alarms and missed detections. The output of the AI includes (1) flag indicating occurrence of abnormality, (2) type of abnormality, and (3) judgment of necessity of notification, such as “Abnormality occurred: true, Type: help, Notification required: yes”. These outputs are passed to the conversation unit and notification unit for subsequent dialogue and notification processing. As a technical effect, by performing integrated judgment of multidimensional features and time-series analysis with AI, the detection unit achieves rapid and high-precision grasp of abnormal situations, which are difficult for human intuition or simple rule-based processing, contributing to reduction of false alarms and improvement of real-time performance. Application fields include elderly monitoring, fraud prevention, and abnormality monitoring in nursing facilities.

The conversation unit can attempt to converse with the user and confirm the situation when an abnormality is detected. For example, the conversation unit attempts to converse with the user and confirm the situation when an abnormality is detected. The conversation unit attempts to converse with the user using AI. By attempting to converse with the user when an abnormality is detected, the situation can be accurately grasped. Specifically, when the conversation unit receives an abnormality detection signal, it uses a large language model to generate a question for the user (e.g., “Is something troubling you right now?”) and speaks it using a speech synthesis engine. The user's response voice is converted to text by a speech recognition AI and the emotional state (e.g., anxiety, fear, confusion, calm) is estimated by an emotion analysis AI. Examples of input to the AI include (1) 1D tensor of the user's response voice, (2) text sequence of speech recognition results, and (3) past conversation history data. The output of the AI includes (1) text of the user's response, (2) estimated emotion label (e.g., anxiety, calm, fear), and (3) urgency score (0.0-1.0), such as “Response: I need help, Emotion: anxiety, Urgency: 0.95”. The conversation unit uses these outputs to ask additional questions or confirm the situation, and instructs the notification unit to send an abnormality notification as needed. The AI model continuously learns from dialogue history and emotion estimation results, automatically generating optimized dialogue strategies for each user. As a technical effect, by combining natural language generation, speech recognition, and emotion analysis with AI, the conversation unit achieves automation, high precision, and speed in situation grasping without human operator intervention, contributing to reduction of false alarms and reduction of user burden. Application fields include elderly monitoring, safety management for people living alone, and abnormality response in nursing facilities.

The notification unit can notify a family of the confirmed abnormality. For example, the notification unit notifies a family of the confirmed abnormality. The notification unit may also notify a family using AI. By notifying a family of the confirmed abnormality, prompt response becomes possible. Specifically, when the notification unit receives an abnormality occurrence notification instruction from the conversation unit or detection unit, it automatically sends an abnormality occurrence notification to the family's smartphone, email address, or dedicated application. When using AI, the notification unit generates structured data including the type of abnormality, occurrence time, estimated user situation, etc., and customizes the notification content. Examples of input to the AI include (1) type of abnormality (e.g., crash, help, scam_call), (2) occurrence time, and (3) user's emotion estimation result and urgency score. The output of the AI includes (1) notification message body (e.g., “A loud impact sound was detected at 12:03:15. Please check immediately.”), (2) notification destination list (e.g., Family A, Family B), and (3) notification priority, such as “Destination: Family A, Content: A call for help was detected, Priority: High”. The notification unit selects multiple notification methods (SMS, email, app notification, etc.) based on these outputs to ensure redundancy and reachability. As a technical effect, by performing notification content generation, destination optimization, and priority control with AI, the notification unit achieves real-time performance, reduction of false alarms, and appropriate information transmission, which are difficult with manual human contact, contributing to prompt response and improvement of peace of mind. Application fields include elderly monitoring, safety management for people living alone, and abnormality response in nursing facilities.

The detection unit may include a setting unit configured to set criteria for abnormality detection. For example, the detection unit includes a setting unit configured to set criteria for abnormality detection. The setting unit may also set criteria for abnormality detection using AI. By setting criteria for abnormality detection, the accuracy of abnormality detection can be improved. Specifically, the detection unit internally includes a setting unit that dynamically manages thresholds and judgment rules used for detecting abnormal sounds and abnormal conversations. This setting unit automatically generates optimal criteria for abnormality detection by referring to AI model output results, past abnormality detection history, user attribute information, environmental change data, etc., in a multidimensional manner. Examples of input to the AI include (1) time-series array of abnormality scores for the past week (e.g., 0.12, 0.15, 0.92, . . . ), (2) environmental data at the time of abnormality occurrence (e.g., temperature 25° C., humidity 40%), and (3) user emotion estimation labels (e.g., anxiety, calm). The setting unit uses these inputs to determine criteria such as abnormality detection threshold (e.g., automatic adjustment from 0.8 to 0.75), priority of detection targets (e.g., scam call patterns as highest priority), and criteria for notification necessity using AI-based rule optimization algorithms (e.g., reinforcement learning, Bayesian optimization, meta-learning, etc.). Examples of AI output include (1) abnormality threshold 0.75, (2) priority detection patterns: help, scam_call, and (3) weight parameters for notification judgment rules. These outputs are immediately reflected in the abnormality judgment logic of the detection unit, greatly improving the accuracy and flexibility of subsequent abnormality detection processing. In subsequent processing, the criteria determined by the setting unit are applied to the judgment algorithm of the detection unit and directly used for determining the occurrence of abnormality and necessity of notification. As a technical effect, by dynamically and individually optimizing criteria for abnormality detection using AI, the detection unit simultaneously achieves adaptability to environmental changes and user characteristics, reduction of false alarms, improvement of detection accuracy, and assurance of real-time performance, which were difficult with conventional static threshold settings and manual rule adjustments. Application fields include elderly monitoring, support for people with disabilities, fraud prevention, abnormality monitoring in nursing facilities, and safety management in home medical care, where individual optimization of criteria for abnormality detection is required in various settings. With these configurations, the present invention not only automates human tasks but also realizes essential advancement of computer technology through autonomous optimization of criteria for abnormality detection by AI.

The notification unit may include a customization unit configured to customize the content of the notification. For example, the notification unit includes a customization unit configured to customize the content of the notification. The customization unit may also customize the content of the notification using AI. By customizing the content of the notification, appropriate information can be provided to the recipient. Specifically, the notification unit internally includes a customization unit that dynamically generates and adjusts the body and format of notification messages sent at the time of abnormality occurrence, notification destinations, notification priority, etc. This customization unit receives multidimensional input such as recipient attributes (e.g., family member's age, IT literacy, past notification response history), type of abnormality (e.g., crash, help, scam_call), user's emotion estimation result, occurrence time, and environmental data using an AI model. Examples of input to the AI include (1) type of abnormality: help, (2) user emotion: anxiety, (3) recipient attribute: elderly, and (4) past notification response history (e.g., response times for the last three notifications: 2 minutes, 5 minutes, no response). The customization unit uses this information to automatically generate the expression of the notification body (e.g., “Please check immediately” or “Please rest assured”), notification method (SMS, email, app notification, etc.), and notification priority (high, medium, low) using AI-based natural language generation models and rule optimization algorithms. Examples of AI output include (1) notification body: “A call for help was detected at 12:03:15. Please check immediately.”, (2) notification destination list: Family A, Family B, (3) notification priority: high, and (4) notification method: SMS+app notification. These outputs are immediately reflected in the sending process of the notification unit, and optimized notifications are automatically sent to each recipient. In subsequent processing, the notification content generated by the customization unit is passed to the actual communication module, and redundant transmission and delivery confirmation processing are performed using multiple methods. As a technical effect, by individually optimizing notification content using AI, the notification unit simultaneously achieves improvement of recipient understanding, promotion of prompt response, reduction of false alarms, and improvement of peace of mind, which were difficult with conventional fixed notifications and uniform transmission. Application fields include elderly monitoring, support for people with disabilities, abnormality response in nursing facilities, safety management in home medical care, and fraud prevention, where individual optimization of notification content is required in various settings. With these configurations, the present invention not only automates human tasks but also realizes essential advancement of computer technology through autonomous optimization of notification content by AI.

The collection unit can estimate a user's emotion and adjust the timing of collecting voice data based on the estimated emotion of the user. For example, if the user is feeling stressed, the collection unit increases the frequency of voice data collection to enable early detection of abnormalities. If the user is relaxed, the collection unit decreases the frequency of voice data collection to prioritize privacy. If the user is in a hurry, the collection unit preferentially collects important voice data. By adjusting the timing of voice data collection based on the user's emotion, early detection of abnormalities and protection of privacy become possible. Emotion estimation is realized using, for example, an emotion engine or generative AI with emotion estimation functions. Generative AI may include text generation AI (e.g., LLM) or multimodal generative AI, but is not limited to these examples. Specifically, the collection unit receives the user's voice or conversation data, activity logs, vital sensor data, etc., as input and estimates the user's emotional state (e.g., anxiety, calm, hurry, stress) in real time using emotion estimation AI (e.g., speech emotion recognition CNN+RNN, multimodal Transformer, etc.). Examples of input to the AI include (1) 1-second voice waveform tensor (16,000 samples), (2) text sequence of speech recognition results (e.g., “I'm in a hurry”), and (3) time-series data of heart rate and activity (e.g., 80 bpm, 120 steps/min). The output of the AI includes (1) emotion label (e.g., stress, calm, hurry), (2) emotion score (0.0-1.0), and (3) estimation confidence, such as “stress, 0.85” or “calm, 0.92”. The collection unit automatically adjusts the timing and frequency of voice data collection based on these outputs. For example, if the label is stress and the score is 0.8 or higher, collection is performed every second; if the label is calm and the score is 0.9 or higher, collection is performed every 10 seconds; if the label is hurry, only important sounds (e.g., loud sounds, calls for help) are preferentially collected, and optimization is performed using AI-based rule-based or reinforcement learning algorithms. In subsequent processing, the voice data collected at the adjusted timing is transferred to the analysis unit or detection unit, contributing to improved accuracy and reduced false alarms in abnormality detection and notification processing. As a technical effect, by combining emotion estimation and collection timing control with AI, the collection unit simultaneously achieves real-time performance, high accuracy, privacy protection, and reduction of user burden, which are difficult with manual human monitoring or uniform collection. Application fields include elderly monitoring, safety management for people living alone, abnormality monitoring in nursing facilities, safety management in home medical care, and stress management support. With these configurations, the present invention not only automates human tasks but also realizes essential advancement of computer technology through emotion-adaptive data collection by AI.

The collection unit can preferentially collect specific frequency bands when collecting sounds in a room. For example, the collection unit preferentially collects the frequency bands of elderly voices to enable early detection of abnormalities. The collection unit preferentially collects the characteristic frequency bands of fraudulent phone calls. The collection unit preferentially collects the frequency bands of sounds of objects falling to enable early detection of accidents. By preferentially collecting specific frequency bands, important voice data can be efficiently collected. Specifically, the collection unit decomposes the voice signal obtained from the microphone into frequency components using spectral analysis algorithms such as fast Fourier transform (FFT) or wavelet transform, and automatically extracts and preferentially collects frequency bands useful for abnormality detection (e.g., elderly voices 200 Hz-800 Hz, characteristic bands of scam calls 1 kHz-3 kHz, low-frequency bands of objects falling 50 Hz-300 Hz) using AI models or rule-based processing. Examples of input to the AI include (1) 1-second voice waveform tensor, (2) frequency spectrum obtained by FFT (e.g., 0-8 kHz as a 256-dimensional vector), and (3) frequency distribution data at the time of past abnormal sound occurrences. The output of the AI includes (1) priority collection bands (e.g., 200-800 Hz, 1-3 kHz), (2) abnormality score for each band, and (3) collection priority list, such as “Priority band: 1-3 kHz, Score: 0.92”. The collection unit uses these outputs to emphasize and preferentially sample signals in the relevant bands using digital filters or software processing in the microphone, reducing the data volume of unnecessary bands. In subsequent processing, voice data from priority bands is transferred to the analysis unit or detection unit, improving the accuracy and real-time performance of abnormality detection. As a technical effect, by combining frequency band selection and priority collection with AI, the collection unit simultaneously achieves data efficiency, improved abnormality detection accuracy, and reduced communication load, which are difficult with uniform collection of all bands or manual band selection. Application fields include elderly monitoring, fraud prevention, abnormality monitoring in nursing facilities, safety management in home medical care, and general acoustic abnormality detection. With these configurations, the present invention not only automates human tasks but also realizes essential advancement of computer technology through frequency band-adaptive data collection by AI.

The collection unit can identify the direction of sounds during voice data collection and apply different collection methods for each direction. For example, if the sound source is near the door, the collection unit collects voice data directed toward the door. If the sound source is near the window, the collection unit collects voice data directed toward the window. If the sound source is in the kitchen, the collection unit collects voice data directed toward the kitchen. By identifying the direction of sounds and applying different collection methods for each direction, the accuracy of voice data collection can be improved. Specifically, the collection unit uses multiple microphone arrays and beamforming technology to estimate the direction of sound sources in a room (e.g., azimuth 0-360 degrees, elevation 0-90 degrees) in real time. AI models (e.g., CNN+RNN for sound source localization, spatial acoustic Transformer, etc.) receive time-series voice tensors and spectrograms from multiple microphones as input and output sound source direction labels (e.g., door direction 30 degrees, window direction 120 degrees, kitchen direction 270 degrees) and signal strength scores for each direction. Examples of input to the AI include (1) 1-second voice tensor from a 4-channel microphone array (4×16,000), (2) spectrogram images from each microphone, and (3) history of past sound source direction estimations. The output of the AI includes (1) sound source direction labels (e.g., door, window, kitchen), (2) signal strength scores for each direction, and (3) collection priority list, such as “Direction: door, Score: 0.88” or “Direction: kitchen, Score: 0.92”. The collection unit uses these outputs to automatically adjust the sensitivity of microphones in the relevant direction or emphasize collection of voice only from the relevant direction using beamforming. In subsequent processing, direction-specified voice data is transferred to the analysis unit or detection unit, contributing to improved accuracy and reduced false alarms in abnormality detection. As a technical effect, by combining sound source direction estimation and direction-specific collection control with AI, the collection unit simultaneously achieves improved collection accuracy, noise reduction, and data efficiency, which are difficult with uniform collection from all directions or manual direction selection. Application fields include elderly monitoring, abnormality monitoring in nursing facilities, safety management in home medical care, and general acoustic abnormality detection. With these configurations, the present invention not only automates human tasks but also realizes essential advancement of computer technology through sound source direction-adaptive data collection by AI.

The collection unit can estimate a user's emotion and determine the priority of voice data to be collected based on the estimated emotion of the user. For example, if the user is feeling anxious, the collection unit prioritizes the collection of abnormal sounds. If the user is relaxed, the collection unit prioritizes the collection of normal conversation sounds. If the user is excited, the collection unit prioritizes the collection of high-frequency voice data. By determining the priority of voice data to be collected based on the user's emotion, important voice data can be efficiently collected. Emotion estimation is realized using, for example, an emotion engine or generative AI with emotion estimation functions. Generative AI may include text generation AI (e.g., LLM) or multimodal generative AI, but is not limited to these examples. Specifically, the collection unit collects multidimensional data such as the user's voice data, conversation history, vital sensor data (e.g., heart rate, activity), and activity logs, and inputs them to emotion estimation AI (e.g., speech emotion recognition CNN+RNN, multimodal Transformer, etc.). Examples of input to the AI include (1) 1-second voice waveform tensor (16,000 samples), (2) text sequence of speech recognition results (e.g., “Please help me”), (3) time-series data of heart rate and activity (e.g., 85 bpm, 100 steps/min), and (4) conversation history data for the past 24 hours. The AI model extracts acoustic features (e.g., MFCC, zero-crossing rate), linguistic features (e.g., phrases indicating anxiety), and biometric features (e.g., sudden increase in heart rate) from these inputs and processes them in multiple layers. The output of the AI includes (1) emotion label (e.g., anxiety, calm, excitement), (2) emotion score (0.0-1.0), and (3) estimation confidence (e.g., 0.92), such as “anxiety, 0.87” or “calm, 0.95”. The collection unit automatically generates priority collection rules for voice data based on these outputs. For example, if the label is anxiety and the score is 0.8 or higher, abnormal sounds (e.g., loud impact sounds, calls for help) are preferentially collected; if the label is calm, normal conversation sounds are prioritized; if the label is excitement, high-frequency voice data (e.g., above 2 kHz) is intensively collected. AI-based priority determination is optimized using rule-based processing or reinforcement learning algorithms (e.g., maximizing abnormality detection accuracy as a reward function). In subsequent processing, the prioritized voice data is transferred to the analysis unit or detection unit, contributing to improved accuracy and reduced false alarms in abnormality detection and notification processing. As a technical effect, by combining emotion estimation and priority control with AI, the collection unit simultaneously achieves real-time performance, high accuracy, privacy protection, and reduction of user burden, which are difficult with manual human monitoring or uniform collection. Application fields include elderly monitoring, safety management for people living alone, abnormality monitoring in nursing facilities, safety management in home medical care, and stress management support. With these configurations, the present invention not only automates human tasks but also realizes essential advancement of computer technology through emotion-adaptive priority data collection by AI.

The collection unit can simultaneously collect environmental data of temperature and humidity in a room during voice data collection. For example, if the temperature in the room is high, the collection unit prioritizes the collection of abnormal sounds. If the humidity in the room is low, the collection unit prioritizes the collection of abnormal sounds caused by dryness. The collection unit optimizes the collection of abnormal sounds based on environmental data in the room. By simultaneously collecting environmental data in the room, it becomes easier to identify the causes of abnormal sounds. Specifically, the collection unit acquires indoor environmental data (e.g., temperature 25.3° C., humidity 38%) from temperature and humidity sensors every minute and records it synchronized with voice data and timestamps. The AI model receives (1) voice waveform tensor (e.g., 16,000 samples for 1 second), (2) temperature and humidity vector at the same time (e.g., 25.3, 38), and (3) time-series data of environmental changes for the past 24 hours as input. The AI learns the correlation between environmental changes and abnormal sound occurrences and automatically generates rules to preferentially collect and analyze abnormal sounds likely to occur during temperature increases (e.g., abnormal operating sounds of equipment) or during humidity decreases (e.g., static noise, sounds caused by dryness). The output of the AI includes (1) priority collection sound types (e.g., crash, static_noise), (2) abnormality score for each environmental condition, and (3) collection priority list, such as “Prioritize crash sounds when temperature is above 28° C., prioritize static_noise when humidity is below 35%”. The collection unit automatically adjusts the sensitivity and collection frequency of the microphone based on these outputs to achieve optimal data collection according to environmental changes. In subsequent processing, the combination of environmental data and voice data is transferred to the analysis unit or detection unit and used for estimating the cause of abnormal sound occurrences and reducing false alarms. As a technical effect, by performing environment-linked collection control with AI, the collection unit simultaneously achieves identification of abnormal occurrence factors, reduction of false alarms, and data efficiency, which are difficult with conventional voice-only collection. Application fields include abnormality monitoring in nursing facilities, safety management in home medical care, equipment abnormality detection, and risk management associated with environmental changes. With these configurations, the present invention not only automates human tasks but also realizes essential advancement of computer technology through environment-adaptive data collection by AI.

The collection unit can refer to a user's activity history and adjust the collection method during voice data collection. For example, the collection unit increases the frequency of voice data collection during time periods when the user has previously generated abnormal sounds. The collection unit predicts time periods when abnormal sounds are likely to occur based on the user's activity history and adjusts the collection method. The collection unit optimizes the collection of abnormal sounds based on the user's activity history. By referring to the user's activity history and adjusting the collection method, the accuracy of abnormal sound collection can be improved. Specifically, the collection unit manages the user's activity logs (e.g., wake-up and sleep times, going out and returning home times, event timestamps for housework and bathing), and past abnormal sound occurrence history (e.g., 2024 Jun. 1 21:15 crash, 2024 Jun. 2 7:05 help) as a time-series database. The AI model receives (1) time-series array of activity history for the past week, (2) list of abnormal sound occurrence times, and (3) current time and day-of-week information as input and predicts time periods and situations with a high probability of abnormal sound occurrence. The output of the AI includes (1) collection frequency schedule (e.g., every minute from 21:00 to 23:00, every 10 minutes at other times), (2) priority collection sound type list, and (3) abnormal occurrence prediction score, such as “Prioritize crash sounds from 21:00 to 23:00, prioritize help sounds from 7:00 to 8:00”. The collection unit automatically adjusts the collection timing and priority sound types based on these outputs to reduce missed abnormal sounds. In subsequent processing, voice data optimized based on activity history is transferred to the analysis unit or detection unit, improving abnormality detection accuracy and real-time performance. As a technical effect, by performing activity history-linked collection control with AI, the collection unit simultaneously achieves improved abnormality detection accuracy, data efficiency, and reduction of false alarms, which are difficult with uniform collection or manual scheduling. Application fields include elderly monitoring, safety management for people living alone, abnormality monitoring in nursing facilities, and safety management in home medical care. With these configurations, the present invention not only automates human tasks but also realizes essential advancement of computer technology through activity history-adaptive data collection by AI.

The analysis unit can estimate a user's emotion and adjust the accuracy of analysis based on the estimated emotion of the user. For example, if the user is feeling anxious, the analysis unit increases the accuracy of analysis to enable early detection of abnormalities. If the user is relaxed, the analysis unit decreases the accuracy of analysis to prioritize privacy. If the user is excited, the analysis unit prioritizes the analysis of important voice data. By adjusting the accuracy of analysis based on the user's emotion, early detection of abnormalities and protection of privacy become possible. Emotion estimation is realized using, for example, an emotion engine or generative AI with emotion estimation functions. Generative AI may include text generation AI (e.g., LLM) or multimodal generative AI, but is not limited to these examples. Specifically, the analysis unit receives voice data from the collection unit, the user's emotion estimation result (e.g., anxiety, calm, excitement), and emotion score (0.0-1.0) as input. The AI model dynamically adjusts parameters of the analysis algorithm (e.g., abnormality detection threshold, resolution of feature extraction, analysis window length) according to the emotion label. For example, if the label is anxiety and the score is 0.8 or higher, the abnormality detection threshold is lowered from 0.7 to 0.6, feature extraction is set to high resolution (e.g., 256-dimensional MFCC), and early detection of abnormal sounds is prioritized. If the label is calm, the threshold is raised to 0.8 and the analysis window is lengthened to emphasize reduction of false alarms and privacy protection. If the label is excitement, high-frequency sounds and sudden changes in volume are intensively analyzed. The output of the AI includes (1) analysis accuracy parameter set, (2) priority analysis sound type list, and (3) analysis window length, such as “Threshold: 0.6, MFCC: 256 dimensions, Priority: crash, help”. The analysis unit automatically optimizes the analysis process based on these outputs, achieving both abnormality detection accuracy and privacy protection. As a technical effect, by performing emotion-adaptive analysis control with AI, the analysis unit simultaneously achieves real-time performance, high accuracy, reduction of false alarms, and privacy protection, which are difficult with uniform analysis or manual parameter adjustment. Application fields include elderly monitoring, safety management for people living alone, abnormality monitoring in nursing facilities, safety management in home medical care, and stress management support. With these configurations, the present invention not only automates human tasks but also realizes essential advancement of computer technology through emotion-adaptive analysis accuracy control by AI.

The analysis unit can refer to past abnormal data and optimize the analysis algorithm during voice data analysis. For example, the analysis unit learns the characteristics of abnormal sounds based on past abnormal data and optimizes the analysis algorithm. The analysis unit refers to past abnormal data to improve the accuracy of abnormal sound detection. The analysis unit analyzes past abnormal data to identify patterns of abnormal sounds. By referring to past abnormal data and optimizing the analysis algorithm, the accuracy of abnormal sound detection can be improved. Specifically, the analysis unit manages previously collected and recorded abnormal sound datasets (e.g., labeled voice waveforms or Mel spectrograms of scam call voices, sounds of objects falling, calls for help) as time-series databases or feature vectors. The analysis unit uses these abnormal data as training data for supervised learning, retraining and fine-tuning convolutional neural networks (CNN), Transformer-type voice classification models with self-attention mechanisms, or hybrid deep learning models. Examples of input to the AI include (1) 1D voice waveform tensor of 16,000 samples, (2) Mel spectrogram image of 128 dimensions×100 frames, and (3) environmental data at the time of abnormal occurrence (e.g., temperature, humidity, time). The analysis unit extracts acoustic features (e.g., MFCC, zero-crossing rate, spectral flatness), linguistic features (e.g., phrases characteristic of scam calls), and time-series features (e.g., changes in volume before and after abnormal occurrence) from these inputs and clusters and classifies patterns of abnormal sounds in multidimensional space. The output of the AI includes (1) abnormal sound labels (e.g., crash, help, scam_call), (2) abnormality score (0.0-1.0), (3) timestamp information of the abnormal occurrence section, and (4) feature vectors of newly discovered abnormal patterns, such as “scam_call, 0.91, 12:10:05-12:10:30, feature vector [0.12, 0.85, . . . ]”. The analysis unit automatically optimizes thresholds and feature extraction parameters for abnormal sound detection based on these outputs, continuously improving detection accuracy and reducing false alarms. In subsequent processing, the optimized analysis algorithm is applied to real-time voice data analysis, improving the accuracy of abnormality judgment information sent to the detection unit or notification unit. As a technical effect, by performing past abnormal data-referenced algorithm optimization with AI, the analysis unit simultaneously achieves adaptability to environmental changes and new abnormal patterns, improved detection accuracy, reduction of false alarms, and assurance of real-time performance, which are difficult with conventional static rule-based or manual parameter adjustment. Application fields include elderly monitoring, fraud prevention, abnormality monitoring in nursing facilities, safety management in home medical care, and general acoustic abnormality detection. With these configurations, the present invention not only automates human tasks but also realizes essential advancement of computer technology through autonomous optimization of abnormal sound analysis algorithms by AI.

The analysis unit can preferentially analyze specific voice patterns during voice data analysis. For example, the analysis unit preferentially analyzes characteristic voice patterns of fraudulent phone calls. The analysis unit preferentially analyzes patterns of sounds of objects falling. The analysis unit preferentially analyzes patterns of calls for help. By preferentially analyzing specific voice patterns, important abnormal sounds can be efficiently detected. Specifically, the analysis unit internally stores predefined abnormal sound patterns (e.g., conversation phrases of scam calls, impact sound spectra of objects falling, acoustic features of calls for help) as feature vectors or templates in a database. The analysis unit frames the voice data received from the collection unit and inputs it to convolutional neural networks (CNN) or Transformer-type voice classification models. Examples of input to the AI include (1) 1-second voice waveform tensor (16,000 samples), (2) Mel spectrogram image of 128 dimensions×100 frames, and (3) text sequence extracted by a speech recognition engine (e.g., “Please transfer money”). The analysis unit extracts acoustic features (e.g., MFCC, spectral peaks), linguistic features (e.g., detection of scam phrases), and time-series features (e.g., sudden changes in volume) from these inputs and performs matching and similarity calculation with high-priority abnormal patterns. The output of the AI includes (1) priority analysis pattern labels (e.g., scam_call, crash, help), (2) pattern match score (0.0-1.0), and (3) timestamp information of the abnormal occurrence section, such as “scam_call, 0.93, 12:10:05-12:10:30” or “crash, 0.88, 12:03:15-12:03:17”. The analysis unit uses these outputs to detect high-priority abnormal sounds in real time and promptly transmit information to the detection unit or notification unit. In subsequent processing, the prioritized abnormal sound data is immediately judged by the detection unit, and the conversation unit or notification unit performs emergency response as needed. As a technical effect, by performing priority analysis of specific patterns with AI, the analysis unit simultaneously achieves rapid and high-precision detection of important abnormal sounds, reduction of false alarms, and improvement of real-time performance, which are difficult with uniform analysis or manual pattern selection. Application fields include fraud prevention, abnormality monitoring in nursing facilities, elderly monitoring, safety management in home medical care, and general acoustic abnormality detection. With these configurations, the present invention not only automates human tasks but also realizes essential advancement of computer technology through priority analysis of abnormal sound patterns by AI.

The analysis unit can estimate a user's emotion and adjust the display method of analysis results based on the estimated emotion of the user. For example, if the user is feeling anxious, the analysis unit displays detailed analysis results. If the user is relaxed, the analysis unit displays concise analysis results. If the user is excited, the analysis unit emphasizes important analysis results. By adjusting the display method of analysis results based on the user's emotion, appropriate information can be provided to the user. Emotion estimation is realized using, for example, an emotion engine or generative AI with emotion estimation functions. Generative AI may include text generation AI (e.g., LLM) or multimodal generative AI, but is not limited to these examples. Specifically, the analysis unit collects multidimensional data such as the user's voice data, conversation history, vital sensor data (e.g., heart rate, activity), and activity logs, and inputs them to emotion estimation AI (e.g., speech emotion recognition CNN+RNN, multimodal Transformer, etc.). Examples of input to the AI include (1) 1-second voice waveform tensor (16,000 samples), (2) text sequence of speech recognition results (e.g., “I'm anxious”), and (3) time-series data of heart rate and activity (e.g., 90 bpm, 80 steps/min). The output of the AI includes (1) emotion label (e.g., anxiety, calm, excitement), (2) emotion score (0.0-1.0), and (3) estimation confidence (e.g., 0.92), such as “anxiety, 0.87” or “calm, 0.95”. The analysis unit automatically adjusts the display method of analysis results based on these outputs. For example, if the label is anxiety and the score is 0.8 or higher, detailed analysis results such as abnormal sound type, occurrence time, detection score, and comparison with past abnormal history are displayed on the dashboard or notification screen; if the label is calm, only concise summaries such as “No abnormality” or “Normal” are displayed; if the label is excitement, detection results of important abnormal sounds (e.g., calls for help) are displayed with highlight colors or pop-ups. In subsequent processing, the displayed analysis results directly influence the decisions and responses of the user or family, contributing to reduction of false alarms and improvement of peace of mind. As a technical effect, by performing emotion-adaptive display control of analysis results with AI, the analysis unit simultaneously achieves improvement of user understanding, promotion of prompt response, reduction of false alarms, and improvement of peace of mind, which are difficult with uniform display or manual customization. Application fields include elderly monitoring, safety management for people living alone, abnormality monitoring in nursing facilities, safety management in home medical care, and stress management support. With these configurations, the present invention not only automates human tasks but also realizes essential advancement of computer technology through emotion-adaptive display of analysis results by AI.

The analysis unit can perform analysis of voice data based on environmental data in a room during the analysis process. For example, when the room temperature is high, the analysis unit prioritizes the analysis of abnormal sounds. When the room humidity is low, the analysis unit prioritizes the analysis of abnormal sounds caused by dryness. The analysis unit optimizes the analysis of abnormal sounds based on the environmental data in the room. By considering the environmental data in the room during analysis, it becomes easier to identify the causes of abnormal sounds. Specifically, the analysis unit synchronizes indoor environmental data obtained from temperature and humidity sensors (e.g., temperature 25.3° C., humidity 38%) with voice data using timestamps, records them, and uses them as input for the analysis algorithm. The AI model receives as input: (1) a voice waveform tensor (e.g., 16,000 samples per second), (2) a temperature and humidity vector at the same time (e.g., 25.3, 38), and (3) time-series data of environmental changes over the past 24 hours. The analysis unit learns the correlation between environmental changes and the occurrence of abnormal sounds, and automatically generates rules to prioritize the analysis of abnormal sounds that are likely to occur when the temperature rises (e.g., abnormal operating sounds of equipment) or when the humidity drops (e.g., static noise, sounds caused by dryness). The AI output includes: (1) prioritized types of sounds for analysis (e.g., crash, static_noise), (2) abnormality scores for each environmental condition, and (3) a list of analysis priorities, such as “prioritize crash sounds when temperature is 28° C. or higher, prioritize static_noise when humidity is 35% or lower.” Based on these outputs, the analysis unit automatically adjusts the parameters of the analysis algorithm (e.g., resolution of feature extraction, abnormality detection threshold) to achieve optimal abnormal sound analysis according to environmental changes. As a subsequent process, combinations of environmental data and voice data are transferred to the detection unit or notification unit and used for estimating the cause of abnormal sounds and reducing false positives. The technical effect is that by performing AI-based environment data-linked analysis control, the analysis unit can simultaneously achieve identification of abnormal occurrence factors, reduction of false positives, and data efficiency, which were difficult with conventional voice-only analysis. Application fields include abnormality monitoring in nursing facilities, safety management in home healthcare, equipment abnormality detection, and risk management associated with environmental changes. With these configurations, the present invention not only automates human tasks but also realizes a fundamental advancement in computer technology through AI-based environment-adaptive abnormal sound analysis.

The analysis unit can improve analysis accuracy by referring to the user's past activity history during the analysis of voice data. For example, the analysis unit improves the accuracy of abnormal sound analysis based on the user's past activity history. The analysis unit predicts time periods when abnormal sounds are likely to occur from the user's past activity history and improves analysis accuracy. The analysis unit analyzes the user's past activity history to identify patterns of abnormal sounds. By referring to the user's past activity history to improve analysis accuracy, the detection accuracy of abnormal sounds can be enhanced. Specifically, the analysis unit manages the user's activity logs (e.g., wake-up and sleep times, times of going out and returning home, timestamps of events such as housework and bathing) and past abnormal sound occurrence history (e.g., 2024 Jun. 1 21:15 crash, 2024 Jun. 2 7:05 help) as a time-series database. The AI model receives as input: (1) a time-series array of activity history for the past week, (2) a list of abnormal sound occurrence times, and (3) current time and day-of-week information, and predicts time periods and situations with a high probability of abnormal sound occurrence. The AI output includes: (1) an analysis accuracy schedule (e.g., high accuracy from 21:00 to 23:00, normal accuracy at other times), (2) a prioritized list of sound types for analysis, and (3) abnormal occurrence prediction scores, such as “prioritize crash sounds from 21:00 to 23:00, prioritize help sounds from 7:00 to 8:00.” Based on these outputs, the analysis unit automatically adjusts the parameters of the analysis algorithm (e.g., resolution of feature extraction, abnormality detection threshold) to achieve optimal abnormal sound analysis according to activity history. As a subsequent process, analysis results optimized based on activity history are transferred to the detection unit or notification unit, improving abnormality detection accuracy and real-time performance. The technical effect is that by performing AI-based activity history-linked analysis control, the analysis unit can simultaneously achieve improved abnormality detection accuracy, data efficiency, and reduction of false positives, which were difficult with conventional uniform analysis or manual scheduling. Application fields include monitoring of elderly persons, safety management for people living alone, abnormality monitoring in nursing facilities, and safety management in home healthcare. With these configurations, the present invention not only automates human tasks but also realizes a fundamental advancement in computer technology through AI-based activity history-adaptive abnormal sound analysis.

The detection unit can estimate the user's emotion and adjust the criteria for abnormality detection based on the estimated emotion. For example, when the user feels anxious, the detection unit tightens the criteria for abnormality detection. When the user is relaxed, the detection unit loosens the criteria. When the user is excited, the detection unit prioritizes the detection of important abnormalities. By adjusting the criteria for abnormality detection based on the user's emotion, early detection of abnormalities and protection of privacy become possible. Emotion estimation is realized using, for example, an emotion engine or generative AI with emotion estimation functions. Generative AI may include text generation AI (e.g., LLM) or multimodal generative AI, but is not limited to these examples. Specifically, the detection unit inputs the user's voice data, conversation history, vital sensor data (e.g., heart rate, activity level), and activity logs received from the collection unit or analysis unit into an emotion estimation AI (e.g., voice emotion recognition CNN+RNN, multimodal Transformer), and estimates the user's emotional state (e.g., anxiety, calm, excitement) and emotion score (0.0-1.0). Example inputs to the AI include: (1) a one-second voice waveform tensor (16,000 samples), (2) a text string of speech recognition results (e.g., “I am anxious”), (3) time-series data of heart rate and activity level (e.g., 90 bpm, 80 steps/min), and (4) conversation history data for the past 24 hours. The AI output includes: (1) emotion labels (e.g., anxiety, calm, excitement), (2) emotion scores (e.g., 0.87), and (3) estimation confidence (e.g., 0.92), such as “anxiety, 0.87” or “calm, 0.95.” Based on these outputs, the detection unit automatically adjusts the criteria for abnormality detection (e.g., abnormality threshold, priority of detection targets, notification necessity judgment rules). For example, if the label is anxiety and the score is 0.8 or higher, the abnormality threshold is lowered from 0.7 to 0.6 to make detection stricter; if the label is calm, the threshold is raised to 0.8 to emphasize reduction of false positives and privacy protection; if the label is excitement, the priority for detecting important abnormalities (e.g., calls for help, impact sounds) is increased. AI-based criteria adjustment is optimized using rule-based processing or reinforcement learning algorithms (e.g., reward functions for minimizing false positive rate and detection delay). As a subsequent process, the adjusted abnormality detection criteria are immediately reflected in the detection unit's judgment algorithm and directly used for determining the presence of abnormalities and the necessity of notification. The technical effect is that by performing AI-based emotion-adaptive abnormality detection criteria control, the detection unit can simultaneously achieve real-time adaptation to user states, reduction of false positives, improved detection accuracy, and privacy protection, which were difficult with conventional static threshold settings or manual rule adjustments. Application fields include monitoring of elderly persons, safety management for people living alone, abnormality monitoring in nursing facilities, safety management in home healthcare, and stress management support. With these configurations, the present invention not only automates human tasks but also realizes a fundamental advancement in computer technology through AI-based emotion-adaptive abnormality detection criteria control.

The detection unit can optimize the detection algorithm by referring to past abnormal data when detecting abnormalities. For example, the detection unit learns the characteristics of abnormalities based on past abnormal data and optimizes the detection algorithm. The detection unit improves the accuracy of abnormality detection by referring to past abnormal data. The detection unit analyzes past abnormal data to identify abnormal patterns. By optimizing the detection algorithm with reference to past abnormal data, the accuracy of abnormality detection can be improved. Specifically, the detection unit manages datasets of abnormal sounds collected and recorded in the past (e.g., labeled voice waveforms or mel spectrograms of scam call voices, sounds of objects falling, calls for help) as time-series databases or feature vectors. The detection unit uses these abnormal data as training data for supervised learning and retrains or fine-tunes convolutional neural networks (CNNs), Transformer-based voice classification models with self-attention mechanisms, or hybrid deep learning models. Example inputs to the AI include: (1) a one-dimensional voice waveform tensor of 16,000 samples, (2) a mel spectrogram image of 128 dimensions×100 frames, and (3) environmental data at the time of abnormal occurrence (e.g., temperature, humidity, time). The detection unit extracts acoustic features (e.g., MFCC, zero-crossing rate, spectral flatness), linguistic features (e.g., phrases characteristic of scam calls), and time-series features (e.g., changes in volume before and after abnormal occurrence) from these inputs, and clusters and classifies abnormal patterns in a multidimensional space. The AI output includes: (1) abnormal labels (e.g., crash, help, scam_call), (2) abnormality scores (0.0-1.0), (3) timestamp information for the abnormal occurrence interval, and (4) feature vectors of newly discovered abnormal patterns, such as “scam_call, 0.91, 12:10:05-12:10:30, feature vector [0.12, 0.85, . . . ].” Based on these outputs, the detection unit automatically optimizes the threshold for abnormality detection and feature extraction parameters, continuously improving detection accuracy and reducing false positives. As a subsequent process, the optimized detection algorithm is applied to real-time abnormality judgment, improving the accuracy of abnormality judgment information sent to the notification unit or conversation unit. The technical effect is that by performing AI-based past abnormal data-referenced algorithm optimization, the detection unit can simultaneously achieve adaptability to environmental changes and new abnormal patterns, improved detection accuracy, reduction of false positives, and real-time performance, which were difficult with conventional static rule-based or manual parameter adjustments. Application fields include monitoring of elderly persons, prevention of scam victimization, abnormality monitoring in nursing facilities, safety management in home healthcare, and general acoustic abnormality detection. With these configurations, the present invention not only automates human tasks but also realizes a fundamental advancement in computer technology through autonomous optimization of abnormality detection algorithms by AI.

The detection unit can preferentially detect specific abnormal patterns when detecting abnormalities. For example, the detection unit preferentially detects characteristic abnormal patterns of scam calls. The detection unit preferentially detects abnormal patterns of sounds of objects falling. The detection unit preferentially detects abnormal patterns of calls for help. By preferentially detecting specific abnormal patterns, important abnormalities can be efficiently detected. Specifically, the detection unit stores predefined abnormal patterns (e.g., conversation phrases of scam calls, impact sound spectra when objects fall, acoustic features of calls for help) as feature vectors or templates in an internal database. The detection unit receives abnormal sound labels, abnormality scores, acoustic features, and linguistic features from the analysis unit, and performs matching and similarity calculations with high-priority abnormal patterns. Example inputs to the AI include: (1) a one-second voice waveform tensor (16,000 samples), (2) a mel spectrogram image of 128 dimensions×100 frames, and (3) text strings extracted by a speech recognition engine (e.g., “Please transfer the money”). The AI output includes: (1) prioritized detection pattern labels (e.g., scam_call, crash, help), (2) pattern match scores (0.0-1.0), and (3) timestamp information for the abnormal occurrence interval, such as “scam_call, 0.93, 12:10:05-12:10:30” or “crash, 0.88, 12:03:15-12:03:17.” Based on these outputs, the detection unit detects high-priority abnormalities in real time and enables rapid information transmission to the notification unit or conversation unit. As a subsequent process, the prioritized detected abnormal data is immediately judged by the notification unit, and emergency response is performed as necessary. The technical effect is that by performing AI-based prioritized detection of specific patterns, the detection unit can simultaneously achieve rapid and high-precision detection of important abnormalities, reduction of false positives, and improved real-time performance, which were difficult with conventional uniform detection or manual pattern selection. Application fields include prevention of scam victimization, abnormality monitoring in nursing facilities, monitoring of elderly persons, safety management in home healthcare, and general acoustic abnormality detection. With these configurations, the present invention not only automates human tasks but also realizes a fundamental advancement in computer technology through AI-based prioritized detection of abnormal patterns.

The detection unit can estimate the user's emotion and determine the priority of abnormality detection based on the estimated emotion. For example, when the user feels anxious, the detection unit prioritizes the detection of abnormalities. When the user is relaxed, the detection unit prioritizes the detection of normal voice data. When the user is excited, the detection unit prioritizes the detection of important abnormalities. By determining the priority of abnormality detection based on the user's emotion, important abnormalities can be efficiently detected. Emotion estimation is realized using, for example, an emotion engine or generative AI with emotion estimation functions. Generative AI may include text generation AI (e.g., LLM) or multimodal generative AI, but is not limited to these examples. Specifically, the detection unit inputs the user's voice data, conversation history, vital sensor data (e.g., heart rate, activity level), and activity logs received from the collection unit or analysis unit into an emotion estimation AI (e.g., voice emotion recognition CNN+RNN, multimodal Transformer), and estimates the user's emotional state (e.g., anxiety, calm, excitement) and emotion score (0.0-1.0). Example inputs to the AI include: (1) a one-second voice waveform tensor (16,000 samples), (2) a text string of speech recognition results (e.g., “Please help me”), (3) time-series data of heart rate and activity level (e.g., 85 bpm, 100 steps/min), and (4) conversation history data for the past 24 hours. The AI output includes: (1) emotion labels (e.g., anxiety, calm, excitement), (2) emotion scores (e.g., 0.87), and (3) estimation confidence (e.g., 0.92), such as “anxiety, 0.87” or “calm, 0.95.” Based on these outputs, the detection unit automatically determines the priority of abnormality detection (e.g., prioritize abnormal sounds, prioritize normal sounds, prioritize high-frequency sounds) and reflects this in the branching process of the abnormality detection algorithm and notification priority control. For example, if the label is anxiety and the score is 0.8 or higher, the detection of abnormal sounds (e.g., calls for help, impact sounds) is given the highest priority; if the label is calm, the detection of normal conversation sounds is prioritized; if the label is excitement, the detection of high-frequency sounds or sudden changes in volume is emphasized. AI-based priority determination is optimized using rule-based processing or reinforcement learning algorithms (e.g., reward functions for maximizing abnormality detection accuracy). As a subsequent process, prioritized detected abnormal data is transferred to the notification unit or conversation unit, contributing to faster abnormality response and reduction of false positives. The technical effect is that by performing AI-based emotion-adaptive abnormality detection priority control, the detection unit can simultaneously achieve real-time performance, high accuracy, privacy protection, and reduced user burden, which were difficult with conventional uniform detection or manual priority settings. Application fields include monitoring of elderly persons, safety management for people living alone, abnormality monitoring in nursing facilities, safety management in home healthcare, and stress management support. With these configurations, the present invention not only automates human tasks but also realizes a fundamental advancement in computer technology through AI-based emotion-adaptive abnormality detection priority control.

The detection unit can perform detection based on environmental data in a room when detecting abnormalities. For example, when the room temperature is high, the detection unit prioritizes the detection of abnormalities. When the room humidity is low, the detection unit prioritizes the detection of abnormalities caused by dryness. The detection unit optimizes abnormality detection based on the environmental data in the room. By considering the environmental data in the room during detection, it becomes easier to identify the causes of abnormalities. Specifically, the detection unit synchronizes indoor environmental data obtained from temperature and humidity sensors (e.g., temperature 25.3° C., humidity 38%) with voice data and analysis results using timestamps, records them, and uses them as input for the detection algorithm. The AI model receives as input: (1) a voice waveform tensor (e.g., 16,000 samples per second), (2) a temperature and humidity vector at the same time (e.g., 25.3, 38), and (3) time-series data of environmental changes over the past 24 hours. The detection unit learns the correlation between environmental changes and the occurrence of abnormalities, and automatically generates rules to prioritize the detection of abnormalities that are likely to occur when the temperature rises (e.g., abnormal operating sounds of equipment) or when the humidity drops (e.g., static noise, sounds caused by dryness). The AI output includes: (1) prioritized types of sounds for detection (e.g., crash, static_noise), (2) abnormality scores for each environmental condition, and (3) a list of detection priorities, such as “prioritize crash sounds when temperature is 28° C. or higher, prioritize static_noise when humidity is 35% or lower.” Based on these outputs, the detection unit automatically adjusts the parameters of the detection algorithm (e.g., resolution of feature extraction, abnormality detection threshold) to achieve optimal abnormality detection according to environmental changes. As a subsequent process, combinations of environmental data and voice data are transferred to the notification unit or conversation unit and used for estimating the cause of abnormality and reducing false positives. The technical effect is that by performing AI-based environment data-linked detection control, the detection unit can simultaneously achieve identification of abnormal occurrence factors, reduction of false positives, and data efficiency, which were difficult with conventional voice-only detection. Application fields include abnormality monitoring in nursing facilities, safety management in home healthcare, equipment abnormality detection, and risk management associated with environmental changes. With these configurations, the present invention not only automates human tasks but also realizes a fundamental advancement in computer technology through AI-based environment-adaptive abnormality detection.

The detection unit can improve detection accuracy by referring to the user's past activity history when detecting abnormalities. For example, the detection unit improves the accuracy of abnormality detection based on the user's past activity history. The detection unit predicts time periods when abnormalities are likely to occur from the user's past activity history and improves detection accuracy. The detection unit analyzes the user's past activity history to identify abnormal patterns. By referring to the user's past activity history to improve detection accuracy, the accuracy of abnormality detection can be enhanced. Specifically, the detection unit manages the user's activity logs (e.g., wake-up and sleep times, times of going out and returning home, timestamps of events such as housework and bathing) and past abnormal occurrence history (e.g., 2024 Jun. 1 21:15 crash, 2024 Jun. 2 7:05 help) as a time-series database. The AI model receives as input: (1) a time-series array of activity history for the past week, (2) a list of abnormal occurrence times, and (3) current time and day-of-week information, and predicts time periods and situations with a high probability of abnormal occurrence. The AI output includes: (1) a detection accuracy schedule (e.g., high accuracy from 21:00 to 23:00, normal accuracy at other times), (2) a prioritized list of sound types for detection, and (3) abnormal occurrence prediction scores, such as “prioritize crash sounds from 21:00 to 23:00, prioritize help sounds from 7:00 to 8:00.” Based on these outputs, the detection unit automatically adjusts the parameters of the detection algorithm (e.g., resolution of feature extraction, abnormality detection threshold) to achieve optimal abnormality detection according to activity history. As a subsequent process, detection results optimized based on activity history are transferred to the notification unit or conversation unit, improving abnormality detection accuracy and real-time performance. The technical effect is that by performing AI-based activity history-linked detection control, the detection unit can simultaneously achieve improved abnormality detection accuracy, data efficiency, and reduction of false positives, which were difficult with conventional uniform detection or manual scheduling. Application fields include monitoring of elderly persons, safety management for people living alone, abnormality monitoring in nursing facilities, and safety management in home healthcare. With these configurations, the present invention not only automates human tasks but also realizes a fundamental advancement in computer technology through AI-based activity history-adaptive abnormality detection.

The conversation unit can estimate the user's emotion and adjust the content of the conversation based on the estimated emotion. For example, when the user feels anxious, the conversation unit conducts conversations to reassure the user. When the user is relaxed, the conversation unit conducts relaxed conversations. When the user is excited, the conversation unit conducts conversations to calm the excitement. By adjusting the content of the conversation based on the user's emotion, appropriate conversations can be provided to the user. Emotion estimation is realized using, for example, an emotion engine or generative AI with emotion estimation functions. Generative AI may include text generation AI (e.g., LLM) or multimodal generative AI, but is not limited to these examples. Specifically, the conversation unit collects multidimensional data such as the user's voice data, conversation history, vital sensor data (e.g., heart rate, activity level), and activity logs, and inputs them into an emotion estimation AI (e.g., voice emotion recognition CNN+RNN, multimodal Transformer). Example inputs to the AI include: (1) a one-second voice waveform tensor (16,000 samples), (2) a text string of speech recognition results (e.g., “I am anxious”), (3) time-series data of heart rate and activity level (e.g., 90 bpm, 80 steps/min), and (4) conversation history data for the past 24 hours. The conversation unit extracts acoustic features (e.g., MFCC, zero-crossing rate), linguistic features (e.g., phrases indicating anxiety), and biological information features (e.g., sudden increase in heart rate) from these inputs and processes them integratively across multiple layers. The AI output includes: (1) emotion labels (e.g., anxiety, calm, excitement), (2) emotion scores (0.0-1.0), and (3) estimation confidence (e.g., 0.92), such as “anxiety, 0.87” or “calm, 0.95.” Based on these outputs, the conversation unit provides prompts such as “reassuring content,” “relaxed content,” or “content to calm excitement” to a conversation content generation AI (large language model, etc.) to generate conversation texts optimized for the user's state. Example inputs to the AI include: (1) estimated emotion label and score, (2) recent conversation history, and (3) type of abnormality detected (e.g., call for help, impact sound). The AI output includes: (1) conversation text (e.g., “Please rest assured. We will contact your family immediately.”), (2) conversation tone instructions (e.g., speak in a calm voice), and (3) additional question lists (e.g., “Do you have any pain?”) such as “Conversation: Please rest assured, Emotion: calm, Tone: calm.” The conversation unit passes these outputs to a speech synthesis engine and speaks to the user in real time. As a subsequent process, the user's response voice is input again into the emotion estimation AI, and the flow of dialogue is dynamically optimized. The technical effect is that by combining AI-based emotion estimation with conversation content generation and tone control, the conversation unit can simultaneously achieve real-time adaptation to user states, increased reassurance, reduction of false positives, and reduced user burden, which were difficult with conventional template responses or manual dialogue. Application fields include monitoring of elderly persons, safety management for people living alone, abnormality response in nursing facilities, safety management in home healthcare, and stress management support. With these configurations, the present invention not only automates human tasks but also realizes a fundamental advancement in computer technology through AI-based emotion-adaptive conversation content generation.

The conversation unit can refer to the user's past conversation history to select the optimal conversation content when an abnormality is detected. For example, the conversation unit refers to the user's past conversation history when the user felt anxious and conducts conversations to reassure the user. The conversation unit refers to the user's past conversation history when the user was relaxed and conducts relaxed conversations. The conversation unit refers to the user's past conversation history when the user was excited and conducts conversations to calm the excitement. By referring to the user's past conversation history to select the optimal conversation content, appropriate conversations can be provided to the user. Specifically, the conversation unit manages a conversation history database for each user (e.g., one year of past dialogue logs, emotion estimation results, conversation content, user response satisfaction scores) in chronological order. When an abnormality is detected, the conversation unit searches for conversation history at the time of the most recent abnormal occurrence or similar emotional state, and extracts conversation patterns in which the user previously showed positive reactions such as reassurance, relaxation, or calmness. Example inputs to the AI include: (1) type of abnormality (e.g., scam_call, crash, help), (2) current emotion label and score (e.g., anxiety, 0.85), and (3) past conversation history data (e.g., abnormal occurrence time, conversation text, user response content, satisfaction score). Based on these inputs, the conversation unit uses a conversation history search AI (e.g., BERT-based semantic similarity search model, time-series clustering algorithm) to select the optimal conversation pattern and provides it as a prompt to a conversation content generation AI (large language model, etc.). The AI output includes: (1) optimal conversation text (e.g., “We contacted your family last time you felt anxious. Please rest assured this time as well.”), (2) conversation tone instructions (e.g., calm voice), and (3) additional question lists (e.g., “How are you feeling now?”) such as “Conversation: Please rest assured, we will respond as before.” The conversation unit passes these outputs to a speech synthesis engine and speaks to the user in real time. As a subsequent process, the user's responses and emotional changes are recorded again in the history database and used to optimize future dialogues. The technical effect is that by performing AI-based conversation history-referenced content optimization, the conversation unit can simultaneously achieve individual optimization for each user, increased reassurance, reduction of false positives, and improved dialogue satisfaction, which were difficult with conventional uniform responses or manual history referencing. Application fields include monitoring of elderly persons, safety management for people living alone, abnormality response in nursing facilities, safety management in home healthcare, and stress management support. With these configurations, the present invention not only automates human tasks but also realizes a fundamental advancement in computer technology through AI-based conversation history-adaptive dialogue content optimization.

The conversation unit can adjust the tone of conversation based on the user's current situation when an abnormality is detected. For example, when the user feels anxious, the conversation unit conducts conversations in a calm tone. When the user is relaxed, the conversation unit conducts conversations in a bright tone. When the user is excited, the conversation unit conducts conversations in a gentle tone. By adjusting the tone of conversation based on the user's current situation, appropriate conversations can be provided to the user. Specifically, the conversation unit collects multidimensional data such as the user's voice data, conversation history, vital sensor data (e.g., heart rate, activity level), activity logs, and environmental data (e.g., time of day, ambient noise level), and inputs them into an emotion estimation AI (e.g., voice emotion recognition CNN+RNN, multimodal Transformer). Example inputs to the AI include: (1) a one-second voice waveform tensor (16,000 samples), (2) a text string of speech recognition results (e.g., “I am anxious”), (3) time-series data of heart rate and activity level (e.g., 90 bpm, 80 steps/min), and (4) current environmental data (e.g., nighttime, silence, noise). The AI output includes: (1) emotion labels (e.g., anxiety, calm, excitement), (2) emotion scores (0.0-1.0), (3) estimation confidence (e.g., 0.92), and (4) recommended tone instructions (e.g., calm, bright, gentle), such as “anxiety, 0.87, tone: calm” or “calm, 0.95, tone: bright.” Based on these outputs, the conversation unit provides tone instructions to a conversation content generation AI (large language model, etc.) to generate conversation texts optimized for the user's situation. Example inputs to the AI include: (1) estimated emotion label and score, (2) recommended tone instructions, and (3) recent conversation history. The AI output includes: (1) conversation text (e.g., “Please rest assured. We will contact your family immediately.”), (2) tone parameters for speech synthesis (e.g., pitch, speed, voice color), and (3) additional question lists, such as “Conversation: Please rest assured, tone: calm.” The conversation unit passes these outputs to a speech synthesis engine and speaks to the user in the specified tone. As a subsequent process, the user's responses and emotional changes are input again into the emotion estimation AI, and the flow of dialogue is dynamically optimized. The technical effect is that by combining AI-based situation-adaptive tone control with conversation content generation, the conversation unit can simultaneously achieve real-time adaptation to user states, increased reassurance, reduction of false positives, and improved user satisfaction, which were difficult with conventional uniform tone responses or manual tone adjustments. Application fields include monitoring of elderly persons, safety management for people living alone, abnormality response in nursing facilities, safety management in home healthcare, and stress management support. With these configurations, the present invention not only automates human tasks but also realizes a fundamental advancement in computer technology through AI-based situation-adaptive conversation tone control.

The conversation unit can estimate the user's emotion and determine the priority of conversation based on the estimated emotion. For example, when the user feels anxious, the conversation unit prioritizes conversations to reassure the user. When the user is relaxed, the conversation unit prioritizes relaxed conversations. When the user is excited, the conversation unit prioritizes conversations to calm the excitement. By determining the priority of conversation based on the user's emotion, important conversations can be conducted efficiently. Emotion estimation is realized using, for example, an emotion engine or generative AI with emotion estimation functions. Generative AI may include text generation AI (e.g., LLM) or multimodal generative AI, but is not limited to these examples. Specifically, the conversation unit collects multidimensional data such as the user's voice data, conversation history, vital sensor data (e.g., heart rate, activity level), and activity logs, and inputs them into an emotion estimation AI (e.g., voice emotion recognition CNN+RNN, multimodal Transformer). Example inputs to the AI include: (1) a one-second voice waveform tensor (16,000 samples), (2) a text string of speech recognition results (e.g., “Please help me”), (3) time-series data of heart rate and activity level (e.g., 85 bpm, 100 steps/min), and (4) conversation history data for the past 24 hours. The AI output includes: (1) emotion labels (e.g., anxiety, calm, excitement), (2) emotion scores (0.0-1.0), and (3) estimation confidence (e.g., 0.92), such as “anxiety, 0.87” or “calm, 0.95.” Based on these outputs, the conversation unit provides priority instructions to a conversation content generation AI (large language model, etc.) to generate conversation texts optimized for the user's state. Example inputs to the AI include: (1) estimated emotion label and score, (2) recent conversation history, and (3) type of abnormality detected. The AI output includes: (1) prioritized conversation text (e.g., “Please rest assured. We will contact your family immediately.”), (2) priority label (e.g., high, medium, low), and (3) additional question lists, such as “Priority conversation: reassuring content, priority: high.” The conversation unit speaks to the user in order of priority and dynamically optimizes the dialogue strategy according to changes in the user's state. As a subsequent process, the user's responses and emotional changes are input again into the emotion estimation AI, and the conversation priority is updated sequentially. The technical effect is that by performing AI-based emotion-adaptive conversation priority control, the conversation unit can simultaneously achieve real-time performance, high accuracy, reduced user burden, and increased reassurance, which were difficult with conventional uniform responses or manual priority settings. Application fields include monitoring of elderly persons, safety management for people living alone, abnormality response in nursing facilities, safety management in home healthcare, and stress management support. With these configurations, the present invention not only automates human tasks but also realizes a fundamental advancement in computer technology through AI-based emotion-adaptive conversation priority control.

The conversation unit can refer to information about the user's family or friends to customize the content of the conversation when an abnormality is detected. For example, the conversation unit conducts reassuring conversations based on information about the user's family or friends. The conversation unit conducts relaxed conversations based on information about the user's family or friends. The conversation unit conducts conversations to calm excitement based on information about the user's family or friends. By referring to information about the user's family or friends to customize the content of the conversation, appropriate conversations can be provided to the user. Specifically, the conversation unit manages a database of the user's family structure, friend list, and contact attributes (e.g., family member's age, relationship, past conversation history, emergency contacts). When an abnormality is detected, the conversation unit refers to information about the user's family or friends and generates personalized conversation texts, such as “We will contact your family member ○○, so please rest assured” or “Please remain calm as you did when you spoke with your friend ΔΔ before.” Example inputs to the AI include: (1) type of abnormality (e.g., scam_call, crash, help), (2) information about the user's family or friends (e.g., family A: mother, friend B: neighbor), and (3) past conversation history with family or friends. Based on these inputs, the conversation unit provides them as prompts to a conversation content generation AI (large language model, etc.) to generate conversation texts optimized for user attributes. The AI output includes: (1) customized conversation text (e.g., “We will contact your family member ○○, so please rest assured.”), (2) conversation tone instructions (e.g., friendly voice), and (3) additional question lists, such as “Conversation: We will contact your family, tone: friendly.” The conversation unit passes these outputs to a speech synthesis engine and speaks to the user in real time. As a subsequent process, the user's responses and emotional changes are input again into the emotion estimation AI, and the dialogue content is dynamically optimized. The technical effect is that by performing AI-based family and friend information-linked conversation content customization, the conversation unit can simultaneously achieve increased reassurance for each user, reduction of false positives, and improved dialogue satisfaction, which were difficult with conventional uniform responses or manual personalization. Application fields include monitoring of elderly persons, safety management for people living alone, abnormality response in nursing facilities, safety management in home healthcare, and stress management support. With these configurations, the present invention not only automates human tasks but also realizes a fundamental advancement in computer technology through AI-based family and friend information-adaptive conversation content generation.

The conversation unit can refer to the user's past activity history to improve the accuracy of conversation when an abnormality is detected. For example, the conversation unit conducts reassuring conversations based on the user's past activity history. The conversation unit conducts relaxed conversations based on the user's past activity history. The conversation unit conducts conversations to calm excitement based on the user's past activity history. By referring to the user's past activity history to improve the accuracy of conversation, appropriate conversations can be provided to the user. Specifically, the conversation unit manages the user's activity logs (e.g., wake-up and sleep times, times of going out and returning home, timestamps of events such as housework and bathing), past abnormal occurrence history, conversation history, and emotion estimation results as a time-series database. When an abnormality is detected, the conversation unit refers to past activity history and conversation patterns at the time of abnormal occurrence, and generates optimal conversation content based on history, such as “When an abnormality occurred at night, you were reassured by contacting your family.” Example inputs to the AI include: (1) type of abnormality (e.g., crash, help), (2) current activity status (e.g., nighttime, out of home), and (3) past activity history and conversation history data. Based on these inputs, the conversation unit provides them as prompts to a conversation content generation AI (large language model, etc.) to generate conversation texts optimized for activity history. The AI output includes: (1) optimal conversation text (e.g., “It is nighttime, but we will contact your family, so please rest assured.”), (2) conversation tone instructions (e.g., calm voice), and (3) additional question lists, such as “Conversation: nighttime response, tone: calm.” The conversation unit passes these outputs to a speech synthesis engine and speaks to the user in real time. As a subsequent process, the user's responses and emotional changes are input again into the emotion estimation AI, and the dialogue content is dynamically optimized. The technical effect is that by performing AI-based activity history-linked conversation content optimization, the conversation unit can simultaneously achieve individual optimization for each user, increased reassurance, reduction of false positives, and improved dialogue satisfaction, which were difficult with conventional uniform responses or manual history referencing. Application fields include monitoring of elderly persons, safety management for people living alone, abnormality response in nursing facilities, safety management in home healthcare, and stress management support. With these configurations, the present invention not only automates human tasks but also realizes a fundamental advancement in computer technology through AI-based activity history-adaptive conversation content generation.

The notification unit can estimate the user's emotion and adjust the content of the notification based on the estimated emotion. For example, when the user feels anxious, the notification unit sends a reassuring notification. When the user is relaxed, the notification unit sends a relaxed notification. When the user is excited, the notification unit sends a notification to calm the excitement. By adjusting the content of the notification based on the user's emotion, appropriate information can be provided to the recipient. Emotion estimation is realized using, for example, an emotion engine or generative AI with emotion estimation functions. Generative AI may include text generation AI (e.g., LLM) or multimodal generative AI, but is not limited to these examples. Specifically, the notification unit inputs the user's voice data, conversation history, vital sensor data (e.g., heart rate, activity level), and activity logs received from the collection unit or analysis unit into an emotion estimation AI (e.g., voice emotion recognition CNN+RNN, multimodal Transformer), and estimates the user's emotional state (e.g., anxiety, calm, excitement) and emotion score (0.0-1.0). Example inputs to the AI include: (1) a one-second voice waveform tensor (16,000 samples), (2) a text string of speech recognition results (e.g., “I am anxious”), (3) time-series data of heart rate and activity level (e.g., 90 bpm, 80 steps/min), and (4) conversation history data for the past 24 hours. The notification unit extracts acoustic features (e.g., MFCC, zero-crossing rate), linguistic features (e.g., phrases indicating anxiety), and biological information features (e.g., sudden increase in heart rate) from these inputs and processes them integratively across multiple layers. The AI output includes: (1) emotion labels (e.g., anxiety, calm, excitement), (2) emotion scores (0.0-1.0), and (3) estimation confidence (e.g., 0.92), such as “anxiety, 0.87” or “calm, 0.95.” Based on these outputs, the notification unit provides prompts such as “reassuring content,” “relaxed content,” or “content to calm excitement” to a notification content generation AI (large language model, etc.) to generate notification texts optimized for the user's state. Example inputs to the AI include: (1) estimated emotion label and score, (2) recent conversation history, and (3) type of abnormality detected (e.g., call for help, impact sound). The AI output includes: (1) notification message body (e.g., “Please rest assured. We have contacted your family.”), (2) notification tone instructions (e.g., calm expression), and (3) notification priority (e.g., high, medium, low), such as “Notification: Please rest assured, Emotion: calm, Priority: high.” Based on these outputs, the notification unit automatically selects the notification destination and method (SMS, email, app notification, etc.) and sends the optimal information to the recipient in real time. As a subsequent process, the notification content is delivered to the family or related parties' devices, and the recipient's response or confirmation status is fed back to the system. The technical effect is that by combining AI-based emotion estimation with notification content generation and priority control, the notification unit can simultaneously achieve real-time adaptation to user states, increased reassurance, reduction of false positives, and promotion of rapid response, which were difficult with conventional template notifications or manual content adjustments. Application fields include monitoring of elderly persons, safety management for people living alone, abnormality response in nursing facilities, safety management in home healthcare, and stress management support. With these configurations, the present invention not only automates human tasks but also realizes a fundamental advancement in computer technology through AI-based emotion-adaptive notification content generation.

The notification unit can select the notification destination based on the user's past contact history when an abnormality is detected. For example, the notification unit sends notifications to family members or friends with whom the user has frequently communicated in the past. The notification unit selects the optimal notification destination based on the user's past contact history. The notification unit selects the person to contact in emergencies based on the user's past contact history. By selecting the notification destination based on the user's past contact history, notifications can be sent quickly to the appropriate person. Specifically, the notification unit manages the user's past notification sending history and response history (e.g., number of notifications to family member A, response time, emergency contact selection tendencies) as a time-series database. When an abnormality is detected, the notification unit inputs past contact history data (e.g., notification destination list for the past month, response rate, emergency contact ranking) into an AI model (e.g., time-series clustering algorithm, decision tree, reinforcement learning model) to automatically select the optimal notification destination. Example inputs to the AI include: (1) type of abnormality (e.g., crash, help, scam_call), (2) notification destination and response history vector for the past 30 days (e.g., family A: 10 times/90% response, family B: 3 times/50% response), and (3) emergency score (e.g., 0.95). The AI output includes: (1) notification destination list (e.g., family A, family B), (2) notification priority (e.g., high, medium, low), and (3) notification method (e.g., SMS, email, app notification), such as “Notification destination: family A, Priority: high, Method: SMS.” Based on these outputs, the notification unit sends notifications in real time to the optimal destination and monitors the response status. As a subsequent process, if there is no response from the notification destination, the system automatically relays the notification to the next contact in order to ensure redundancy and reachability. The technical effect is that by performing AI-based contact history-referenced notification destination optimization, the notification unit can simultaneously achieve rapidity, reachability, reduction of false positives, and appropriate information transmission, which were difficult with conventional uniform notifications or manual destination selection. Application fields include monitoring of elderly persons, safety management for people living alone, abnormality response in nursing facilities, safety management in home healthcare, and optimization of emergency contact networks. With these configurations, the present invention not only automates human tasks but also realizes a fundamental advancement in computer technology through AI-based contact history-adaptive notification destination selection.

The notification unit can adjust the notification method based on the user's current situation when an abnormality is detected. For example, when the user is out, the notification unit sends notifications to the user's smartphone. When the user is at home, the notification unit sends notifications directly to the family. When the user is in an emergency, the notification unit sends notifications simultaneously to multiple contacts. By adjusting the notification method based on the user's current situation, notifications can be sent quickly and appropriately. Specifically, the notification unit obtains the user's current location information (e.g., GPS coordinates, Wi-Fi access point information), activity status (e.g., out, at home, sleeping, exercising), and device connection status (e.g., smartphone online, landline available) in real time, and inputs this information into an AI model (e.g., multimodal neural network for situation recognition, decision algorithm). Example inputs to the AI include: (1) current location vector (e.g., latitude and longitude), (2) activity status label (e.g., out, at home, sleeping), (3) device connection status (e.g., smartphone: online, landline: offline), and (4) type of abnormality and emergency score. The AI output includes: (1) notification method (e.g., smartphone, family device, simultaneous multiple sending), (2) notification priority, and (3) sending timing, such as “Method: smartphone, Priority: high, Timing: immediate” or “Method: family device, Priority: medium, Timing: normal.” Based on these outputs, the notification unit automatically sends notifications using the optimal method and timing, and also performs delivery confirmation and resend control. As a subsequent process, if the notification is not delivered, the system switches to other methods or sends redundant notifications using multiple methods. The technical effect is that by performing AI-based situation recognition notification method optimization, the notification unit can simultaneously achieve real-time performance, reachability, reduction of false positives, and reduced user burden, which were difficult with conventional uniform sending or manual method selection. Application fields include monitoring of elderly persons, safety management for people living alone, abnormality response in nursing facilities, safety management in home healthcare, and optimization of emergency contact networks. With these configurations, the present invention not only automates human tasks but also realizes a fundamental advancement in computer technology through AI-based situation-adaptive notification method control.

The notification unit can estimate the user's emotion and determine the priority of notification based on the estimated emotion. For example, when the user feels anxious, the notification unit prioritizes sending important notifications. When the user is relaxed, the notification unit prioritizes sending normal notifications. When the user is excited, the notification unit prioritizes sending urgent notifications. By determining the priority of notification based on the user's emotion, important notifications can be sent efficiently. Emotion estimation is realized using, for example, an emotion engine or generative AI with emotion estimation functions. Generative AI may include text generation AI (e.g., LLM) or multimodal generative AI, but is not limited to these examples. Specifically, the notification unit inputs the user's voice data, conversation history, vital sensor data (e.g., heart rate, activity level), and activity logs received from the collection unit or analysis unit into an emotion estimation AI (e.g., voice emotion recognition CNN+RNN, multimodal Transformer), and estimates the user's emotional state (e.g., anxiety, calm, excitement) and emotion score (0.0-1.0). Example inputs to the AI include: (1) a one-second voice waveform tensor (16,000 samples), (2) a text string of speech recognition results (e.g., “I am anxious”), (3) time-series data of heart rate and activity level (e.g., 90 bpm, 80 steps/min), and (4) conversation history data for the past 24 hours. The AI output includes: (1) emotion labels (e.g., anxiety, calm, excitement), (2) emotion scores (0.0-1.0), and (3) estimation confidence (e.g., 0.92), such as “anxiety, 0.87” or “calm, 0.95.” Based on these outputs, the notification unit inputs them into a notification priority determination AI (rule-based or reinforcement learning algorithm, etc.) to automatically determine the priority for each notification content and destination. The AI output includes: (1) notification priority label (e.g., high, medium, low), (2) notification body, and (3) notification method, such as “Priority: high, Body: Emergency response required.” Based on these outputs, the notification unit sends notifications in order of priority and dynamically optimizes the notification strategy according to the recipient's response status. As a subsequent process, notifications according to priority are delivered to family members or related parties, contributing to rapid response and reduction of false positives. The technical effect is that by combining AI-based emotion estimation with notification priority control, the notification unit can simultaneously achieve real-time performance, high accuracy, reduced user burden, and increased reassurance, which were difficult with conventional uniform notifications or manual priority settings. Application fields include monitoring of elderly persons, safety management for people living alone, abnormality response in nursing facilities, safety management in home healthcare, and stress management support. With these configurations, the present invention not only automates human tasks but also realizes a fundamental advancement in computer technology through AI-based emotion-adaptive notification priority control.

The notification unit can customize the content of the notification based on information about the user's family or friends when an abnormality is detected. For example, the notification unit sends reassuring notifications based on information about the user's family or friends. The notification unit sends relaxed notifications based on information about the user's family or friends. The notification unit sends notifications to calm excitement based on information about the user's family or friends. By customizing the content of the notification based on information about the user's family or friends, appropriate information can be provided to the recipient. Specifically, the notification unit manages a database of the user's family structure, friend list, and contact attributes (e.g., family member's age, relationship, past notification response history, emergency contacts). When an abnormality is detected, the notification unit inputs information about the user's family or friends (e.g., family A: mother, friend B: neighbor), past notification history to family or friends, and response tendencies into an AI model (e.g., attribute-adaptive large language model, rule optimization algorithm) to automatically generate notification content optimized for recipient attributes. Example inputs to the AI include: (1) type of abnormality (e.g., scam_call, crash, help), (2) notification destination attributes (e.g., elderly, low IT literacy), and (3) past notification response history (e.g., response times for the last three notifications: 2 minutes, 5 minutes, no response). The AI output includes: (1) customized notification body (e.g., “We have contacted your family member ○○, so please rest assured.”), (2) notification tone instructions (e.g., friendly expression), and (3) notification priority, such as “Notification: Family contacted, Tone: friendly, Priority: high.” Based on these outputs, the notification unit automatically sends optimized notifications to each recipient and monitors the response status. As a subsequent process, notification content and response history are recorded in the system and used to optimize future notifications. The technical effect is that by performing AI-based family and friend information-linked notification content customization, the notification unit can simultaneously achieve increased reassurance for each recipient, reduction of false positives, rapid response, and improved notification satisfaction, which were difficult with conventional uniform notifications or manual personalization. Application fields include monitoring of elderly persons, safety management for people living alone, abnormality response in nursing facilities, safety management in home healthcare, and stress management support. With these configurations, the present invention not only automates human tasks but also realizes a fundamental advancement in computer technology through AI-based family and friend information-adaptive notification content generation.

The notification unit can adjust the notification method based on the user's past activity history when an abnormality is detected. For example, the notification unit selects the optimal notification method based on the user's past activity history. The notification unit selects the optimal notification method for emergencies based on the user's past activity history. The notification unit refers to the user's past activity history to adjust the notification method. By adjusting the notification method based on the user's past activity history, notifications can be sent quickly and appropriately. Specifically, the notification unit manages the user's activity logs (e.g., wake-up and sleep times, times of going out and returning home, timestamps of events such as housework and bathing), past abnormal occurrence history, and notification sending history (e.g., notification method and response rate by time of day) as a time-series database. When an abnormality is detected, the notification unit inputs past activity history and notification history data (e.g., SMS is effective at night, app notifications are effective during the day) into an AI model (e.g., time-series pattern recognition algorithm, reinforcement learning model) to automatically select the optimal notification method. Example inputs to the AI include: (1) current time and day-of-week information, (2) time-series array of activity history for the past week, (3) past notification method and response history, and (4) type of abnormality and emergency score. The AI output includes: (1) notification method (e.g., SMS, email, app notification), (2) sending timing, and (3) notification priority, such as “Method: SMS, Timing: immediate, Priority: high” or “Method: app notification, Timing: normal, Priority: medium.” Based on these outputs, the notification unit automatically sends notifications using the optimal method and timing, and also performs delivery confirmation and resend control. As a subsequent process, if the notification is not delivered, the system switches to other methods or sends redundant notifications using multiple methods. The technical effect is that by performing AI-based activity history-linked notification method optimization, the notification unit can simultaneously achieve real-time performance, reachability, reduction of false positives, and reduced user burden, which were difficult with conventional uniform sending or manual method selection. Application fields include monitoring of elderly persons, safety management for people living alone, abnormality response in nursing facilities, safety management in home healthcare, and optimization of emergency contact networks. With these configurations, the present invention not only automates human tasks but also realizes a fundamental advancement in computer technology through AI-based activity history-adaptive notification method control.

The setting unit can estimate a user's emotion and set criteria for abnormality detection based on the estimated emotion of the user. For example, when the user is feeling anxious, the setting unit sets stricter criteria for abnormality detection. When the user is relaxed, the setting unit sets more lenient criteria. When the user is excited, the setting unit sets criteria that prioritize the detection of important abnormalities. By setting criteria for abnormality detection based on the user's emotion, early detection of abnormalities and protection of privacy can be achieved. Emotion estimation is realized, for example, by using an emotion engine or a generative AI with emotion estimation functions. The generative AI may be a text generation AI (such as an LLM) or a multimodal generative AI, but is not limited to these examples. Specifically, the setting unit inputs the user's voice data, conversation history, vital sensor data (e.g., heart rate, activity level), and activity logs obtained from the collection unit or analysis unit into an emotion estimation AI (e.g., voice emotion recognition CNN+RNN, multimodal Transformer, etc.). Examples of inputs to the AI include: (1) a one-second voice waveform tensor (16,000 samples); (2) a text sequence of speech recognition results (e.g., “I am anxious”); (3) time-series data of heart rate and activity (e.g., 90 bpm, 80 steps/min); and (4) conversation history data for the past 24 hours. The setting unit extracts acoustic features (e.g., MFCC, zero-crossing rate), linguistic features (e.g., phrases indicating anxiety), and biometric features (e.g., sudden increase in heart rate) from these inputs and processes them integratively across multiple layers. The AI outputs (1) emotion labels (e.g., anxiety, calm, excitement); (2) emotion scores (0.0-1.0); and (3) estimation confidence (e.g., 0.92), in formats such as “anxiety, 0.87” or “calm, 0.95”. Based on these outputs, the setting unit automatically sets criteria for abnormality detection (e.g., abnormality threshold, priority of detection targets, notification necessity judgment rules). For example, if the label is anxiety and the score is 0.8 or higher, the abnormality threshold is lowered from 0.7 to 0.6 to make detection stricter; if the label is calm, the threshold is raised to 0.8 to reduce false positives and emphasize privacy protection; if the label is excitement, the priority for detecting important abnormalities (e.g., calls for help, impact sounds) is increased. Criteria setting by AI is optimized using rule-based processing or reinforcement learning algorithms (e.g., reward functions for minimizing false positive rate and detection delay). Subsequently, the set criteria for abnormality detection are immediately reflected in the judgment algorithms of the detection unit and notification unit, and are directly used to determine the presence of abnormalities and the necessity of notification. The technical effect is that, by having the setting unit perform emotion-adaptive abnormality detection criteria setting using AI, real-time adaptation to user states, reduction of false positives, improvement of detection accuracy, and privacy protection—which were difficult with conventional static threshold settings or manual rule adjustments—can be simultaneously achieved. Application fields include elderly monitoring, safety management for people living alone, abnormality monitoring in care facilities, safety management in home medical care, and stress management support. With these configurations, the present invention not only automates human tasks but also realizes a fundamental advancement in computer technology through AI-based emotion-adaptive abnormality detection criteria setting.

The setting unit can refer to past abnormal data when setting criteria for abnormality detection and select optimal criteria. For example, the setting unit optimizes criteria for abnormality detection based on past abnormal data. The setting unit adjusts criteria for abnormality detection by referring to past abnormal data. The setting unit analyzes past abnormal data and sets criteria for abnormality detection. By selecting optimal criteria with reference to past abnormal data, the accuracy of abnormality detection can be improved. Specifically, the setting unit manages datasets of abnormal sounds collected and recorded in the past (e.g., labeled voice waveforms or mel spectrograms of scam calls, sounds of objects falling, calls for help) as time-series databases or feature vectors. The setting unit uses these abnormal data as training data for supervised learning and retrains or fine-tunes convolutional neural networks (CNNs), Transformer-based voice classification models with self-attention mechanisms, or hybrid deep learning models. Examples of inputs to the AI include: (1) one-dimensional voice waveform tensors of 16,000 samples; (2) mel spectrogram images of 128 dimensions×100 frames; and (3) environmental data at the time of abnormality occurrence (e.g., temperature, humidity, time). The setting unit extracts acoustic features (e.g., MFCC, zero-crossing rate, spectral flatness), linguistic features (e.g., phrases characteristic of scam calls), and time-series features (e.g., changes in volume before and after abnormality occurrence) from these inputs, and clusters and classifies abnormal sound patterns in multidimensional space. The AI outputs (1) parameter sets for abnormality detection criteria (e.g., abnormality threshold, feature extraction parameters); (2) detection priority lists for each type of abnormality; and (3) feature vectors of newly discovered abnormal patterns, in formats such as “scam_call: threshold 0.65, crash: threshold 0.7”. Based on these outputs, the setting unit automatically optimizes criteria for abnormality detection and continuously improves detection accuracy and reduction of false positives. Subsequently, the optimized criteria are immediately reflected in the judgment algorithms of the detection unit and notification unit, and are directly used to determine the presence of abnormalities and the necessity of notification. The technical effect is that, by having the setting unit perform AI-based optimization of criteria with reference to past abnormal data, adaptation to environmental changes and new abnormal patterns, improvement of detection accuracy, reduction of false positives, and real-time capability—which were difficult with conventional static rule-based or manual parameter adjustments—can be simultaneously achieved. Application fields include elderly monitoring, fraud prevention, abnormality monitoring in care facilities, safety management in home medical care, and general acoustic abnormality detection. With these configurations, the present invention not only automates human tasks but also realizes a fundamental advancement in computer technology through AI-based autonomous optimization of abnormality detection criteria.

The setting unit can estimate a user's emotion and customize criteria for abnormality detection based on the estimated emotion of the user. For example, when the user is feeling anxious, the setting unit customizes the criteria for abnormality detection to be stricter. When the user is relaxed, the setting unit customizes the criteria to be more lenient. When the user is excited, the setting unit customizes the criteria to prioritize the detection of important abnormalities. By customizing criteria for abnormality detection based on the user's emotion, early detection of abnormalities and protection of privacy can be achieved. Emotion estimation is realized, for example, by using an emotion engine or a generative AI with emotion estimation functions. The generative AI may be a text generation AI (such as an LLM) or a multimodal generative AI, but is not limited to these examples. Specifically, the setting unit inputs the user's voice data, conversation history, vital sensor data (e.g., heart rate, activity level), and activity logs into an emotion estimation AI (e.g., voice emotion recognition CNN+RNN, multimodal Transformer, etc.). Examples of inputs to the AI include: (1) a one-second voice waveform tensor (16,000 samples); (2) a text sequence of speech recognition results (e.g., “I am anxious”); (3) time-series data of heart rate and activity (e.g., 90 bpm, 80 steps/min); and (4) conversation history data for the past 24 hours. The setting unit extracts acoustic features (e.g., MFCC, zero-crossing rate), linguistic features (e.g., phrases indicating anxiety), and biometric features (e.g., sudden increase in heart rate) from these inputs and processes them integratively across multiple layers. The AI outputs (1) emotion labels (e.g., anxiety, calm, excitement); (2) emotion scores (0.0-1.0); and (3) estimation confidence (e.g., 0.92), in formats such as “anxiety, 0.87” or “calm, 0.95”. Based on these outputs, the setting unit customizes criteria for abnormality detection (e.g., abnormality threshold, priority of detection targets, notification necessity judgment rules) for each user. For example, if the label is anxiety and the score is 0.8 or higher, the abnormality threshold is lowered from 0.7 to 0.6 to make detection stricter; if the label is calm, the threshold is raised to 0.8 to reduce false positives and emphasize privacy protection; if the label is excitement, the priority for detecting important abnormalities (e.g., calls for help, impact sounds) is increased. Criteria customization by AI is optimized using rule-based processing or reinforcement learning algorithms (e.g., reward functions for minimizing false positive rate and detection delay). Subsequently, the customized criteria for abnormality detection are immediately reflected in the judgment algorithms of the detection unit and notification unit, and are directly used to determine the presence of abnormalities and the necessity of notification. The technical effect is that, by having the setting unit perform emotion-adaptive abnormality detection criteria customization using AI, real-time adaptation to user states, reduction of false positives, improvement of detection accuracy, and privacy protection—which were difficult with conventional static threshold settings or manual rule adjustments—can be simultaneously achieved. Application fields include elderly monitoring, safety management for people living alone, abnormality monitoring in care facilities, safety management in home medical care, and stress management support. With these configurations, the present invention not only automates human tasks but also realizes a fundamental advancement in computer technology through AI-based emotion-adaptive abnormality detection criteria customization.

The setting unit can refer to information of the user's family or friends when setting criteria for abnormality detection and adjust the criteria. For example, the setting unit adjusts criteria for abnormality detection based on information of the user's family or friends. The setting unit optimizes criteria for abnormality detection by referring to information of the user's family or friends. The setting unit sets criteria for abnormality detection based on information of the user's family or friends. By adjusting criteria with reference to information of the user's family or friends, the accuracy of abnormality detection can be improved. Specifically, the setting unit manages the user's family structure, friend list, and contact attributes (e.g., family member's age, relationship, past conversation history, emergency contacts) as a database. When setting criteria for abnormality detection, the setting unit inputs family and friend attribute information and past abnormality response history (e.g., cases where family member A responded quickly, cases where friend B responded at night) into an AI model (e.g., attribute-adaptive large language model, decision-making algorithm), and automatically generates criteria for abnormality detection optimized for recipient attributes and response tendencies. Examples of inputs to the AI include: (1) family/friend attribute vectors (e.g., age, relationship, response tendency); (2) past abnormality response history (e.g., response time, satisfaction score); and (3) abnormality type and urgency score. The AI outputs (1) parameter sets for abnormality detection criteria (e.g., threshold 0.65 for family member A, threshold 0.7 for friend B); (2) notification priority lists; and (3) recommended response rules, in formats such as “family member A: threshold 0.65, priority: high”. Based on these outputs, the setting unit automatically adjusts criteria for abnormality detection and realizes optimal abnormality detection according to family or friend attributes and response tendencies. Subsequently, the adjusted criteria are immediately reflected in the judgment algorithms of the detection unit and notification unit, and are directly used to determine the presence of abnormalities and the necessity of notification. The technical effect is that, by having the setting unit perform AI-based adjustment of criteria in cooperation with family and friend information, improvement of recipient reassurance, reduction of false positives, prompt response, and improvement of detection accuracy—which were difficult with conventional uniform criteria or manual individualization—can be simultaneously achieved. Application fields include elderly monitoring, safety management for people living alone, abnormality monitoring in care facilities, safety management in home medical care, and stress management support. With these configurations, the present invention not only automates human tasks but also realizes a fundamental advancement in computer technology through AI-based family/friend information-adaptive abnormality detection criteria setting.

The customization unit can estimate a user's emotion and customize the content of the notification based on the estimated emotion of the user. For example, when the user is feeling anxious, the customization unit customizes the notification to provide reassuring content. When the user is relaxed, the customization unit customizes the notification to provide relaxed content. When the user is excited, the customization unit customizes the notification to provide content that calms excitement. By customizing the content of the notification based on the user's emotion, appropriate information can be provided to the recipient. Emotion estimation is realized, for example, by using an emotion engine or a generative AI with emotion estimation functions. The generative AI may be a text generation AI (such as an LLM) or a multimodal generative AI, but is not limited to these examples. Specifically, the customization unit inputs multidimensional data such as the user's voice data obtained from the collection unit or analysis unit (e.g., one-second voice waveform tensor of 16,000 samples), conversation history (e.g., text sequence for the past 24 hours), vital sensor data (e.g., heart rate 90 bpm, activity level 80 steps/min), and activity logs (e.g., times of going out and returning home) into an emotion estimation AI (e.g., voice emotion recognition CNN+RNN, multimodal Transformer). Examples of inputs to the AI include: (1) voice waveform tensor; (2) text sequence of speech recognition results (e.g., “I am anxious”); (3) time-series data of heart rate and activity; and (4) conversation history data for the past 24 hours. The customization unit extracts acoustic features (e.g., MFCC, zero-crossing rate), linguistic features (e.g., phrases indicating anxiety), and biometric features (e.g., sudden increase in heart rate) from these inputs and processes them integratively across multiple layers. The AI outputs (1) emotion labels (e.g., anxiety, calm, excitement); (2) emotion scores (0.0-1.0); and (3) estimation confidence (e.g., 0.92), in formats such as “anxiety, 0.87” or “calm, 0.95”. Based on these outputs, the customization unit provides prompts such as “reassuring content”, “relaxed content”, or “content to calm excitement” to a notification content generation AI (such as a large language model) and generates notification messages optimized for the user's state. Examples of inputs to the AI include: (1) estimated emotion label and score; (2) recent conversation history; and (3) type of abnormality detected (e.g., calls for help, impact sounds). The AI outputs (1) notification message body (e.g., “Please rest assured. Your family has been contacted.”); (2) notification tone instructions (e.g., calm expression); and (3) notification priority (e.g., high, medium, low), in formats such as “Notification: Please rest assured, Emotion: calm, Priority: high”. Based on these outputs, the customization unit automatically selects the notification destination and method (SMS, email, app notification, etc.) and sends the optimal information to the recipient in real time. Subsequently, the notification content is delivered to the devices of family members or related parties, and the recipient's response or confirmation status is fed back to the system. The technical effect is that, by combining AI-based emotion estimation and notification content generation/priority control, the customization unit can simultaneously achieve real-time adaptation to user states, improvement of reassurance, reduction of false positives, and promotion of prompt response—which were difficult with conventional template notifications or manual content adjustments. Application fields include elderly monitoring, safety management for people living alone, abnormality response in care facilities, safety management in home medical care, and stress management support. With these configurations, the present invention not only automates human tasks but also realizes a fundamental advancement in computer technology through AI-based emotion-adaptive notification content customization.

The customization unit can refer to past notification history when customizing the content of the notification and select optimal content. For example, the customization unit selects optimal notification content based on past notification history. The customization unit adjusts notification content by referring to past notification history. The customization unit analyzes past notification history and sets optimal notification content. By selecting optimal content with reference to past notification history, appropriate information can be provided to the recipient. Specifically, the customization unit manages a notification history database for each user (e.g., notification transmission logs for the past year, notification content, whether the recipient responded, satisfaction scores) in chronological order. When an abnormality is detected, the customization unit searches notification history for recent or similar situations and extracts notification patterns that elicited positive responses from recipients, such as prompt response, reassurance, or satisfaction. Examples of inputs to the AI include: (1) type of abnormality (e.g., scam_call, crash, help); (2) current emotion label and score (e.g., anxiety, 0.85); and (3) past notification history data (e.g., time of abnormality occurrence, notification message, recipient response, satisfaction score). Based on these inputs, the customization unit uses a notification history search AI (e.g., BERT-based semantic similarity search model, time-series clustering algorithm) to select optimal notification patterns and provides them as prompts to a notification content generation AI (such as a large language model). The AI outputs (1) optimal notification message (e.g., “We contacted your family last time you were anxious. Please rest assured this time as well.”); (2) notification tone instructions (e.g., calm expression); and (3) additional notification recipient list (e.g., family member A, friend B), in formats such as “Notification: Please rest assured, we will respond as before”. Based on these outputs, the customization unit automatically generates notification content and sends it to the recipient in real time. Subsequently, notification content and response history are recorded in the system and used to optimize future notifications. The technical effect is that, by having the customization unit perform AI-based optimization of notification content with reference to notification history, individual optimization for each recipient, improvement of reassurance, reduction of false positives, and improvement of notification satisfaction—which were difficult with conventional uniform notifications or manual history reference—can be simultaneously achieved. Application fields include elderly monitoring, safety management for people living alone, abnormality response in care facilities, safety management in home medical care, and stress management support. With these configurations, the present invention not only automates human tasks but also realizes a fundamental advancement in computer technology through AI-based notification history-adaptive notification content optimization.

The customization unit can estimate a user's emotion and customize the priority of notifications based on the estimated emotion of the user. For example, when the user is feeling anxious, the customization unit customizes notifications to prioritize important notifications. When the user is relaxed, the customization unit customizes notifications to prioritize normal notifications. When the user is excited, the customization unit customizes notifications to prioritize urgent notifications. By customizing the priority of notifications based on the user's emotion, important notifications can be efficiently sent. Emotion estimation is realized, for example, by using an emotion engine or a generative AI with emotion estimation functions. The generative AI may be a text generation AI (such as an LLM) or a multimodal generative AI, but is not limited to these examples. Specifically, the customization unit inputs the user's voice data, conversation history, vital sensor data (e.g., heart rate, activity level), and activity logs obtained from the collection unit or analysis unit into an emotion estimation AI (e.g., voice emotion recognition CNN+RNN, multimodal Transformer, etc.) to estimate the user's emotional state (e.g., anxiety, calm, excitement) and emotion score (0.0-1.0). Examples of inputs to the AI include: (1) a one-second voice waveform tensor (16,000 samples); (2) a text sequence of speech recognition results (e.g., “I am anxious”); (3) time-series data of heart rate and activity (e.g., 90 bpm, 80 steps/min); and (4) conversation history data for the past 24 hours. The AI outputs (1) emotion labels (e.g., anxiety, calm, excitement); (2) emotion scores (0.0-1.0); and (3) estimation confidence (e.g., 0.92), in formats such as “anxiety, 0.87” or “calm, 0.95”. Based on these outputs, the customization unit inputs them into a notification priority determination AI (rule-based or reinforcement learning algorithm, etc.), which automatically determines the priority for each notification content and recipient. The AI outputs (1) notification priority label (e.g., high, medium, low); (2) notification message body; and (3) notification method, in formats such as “Priority: high, Message: Emergency response required”. Based on these outputs, the customization unit sends notifications in order of priority and dynamically optimizes the notification strategy according to the recipient's response status. Subsequently, notifications according to priority are delivered to family members or related parties, contributing to prompt response and reduction of false positives. The technical effect is that, by combining AI-based emotion estimation and notification priority control, the customization unit can simultaneously achieve real-time capability, high accuracy, reduction of user burden, and improvement of reassurance—which were difficult with conventional uniform notifications or manual priority settings. Application fields include elderly monitoring, safety management for people living alone, abnormality response in care facilities, safety management in home medical care, and stress management support. With these configurations, the present invention not only automates human tasks but also realizes a fundamental advancement in computer technology through AI-based emotion-adaptive notification priority customization.

The customization unit can refer to information of the user's family or friends when customizing the content of the notification and adjust the content. For example, the customization unit adjusts the notification to provide reassuring content based on information of the user's family or friends. The customization unit adjusts the notification to provide relaxed content based on information of the user's family or friends. The customization unit adjusts the notification to provide content that calms excitement based on information of the user's family or friends. By adjusting the content with reference to information of the user's family or friends, appropriate information can be provided to the recipient. Specifically, the customization unit manages the user's family structure, friend list, and contact attributes (e.g., family member's age, relationship, past notification response history, emergency contacts) as a database. When an abnormality is detected, the customization unit inputs information of the user's family or friends (e.g., family member A: mother, friend B: neighbor), past notification history to family or friends, and response tendencies into an AI model (e.g., attribute-adaptive large language model, rule optimization algorithm), and automatically generates notification content optimized for recipient attributes. Examples of inputs to the AI include: (1) type of abnormality (e.g., scam_call, crash, help); (2) recipient attributes (e.g., elderly, low IT literacy); and (3) past notification response history (e.g., response times for the last three notifications: 2 minutes, 5 minutes, no response). The AI outputs (1) customized notification message (e.g., “We have contacted your family member ○○, so please rest assured.”); (2) notification tone instructions (e.g., friendly expression); and (3) notification priority, in formats such as “Notification: Family contacted, Tone: friendly, Priority: high”. Based on these outputs, the customization unit automatically sends optimized notifications to each recipient and monitors response status. Subsequently, notification content and response history are recorded in the system and used to optimize future notifications. The technical effect is that, by having the customization unit perform AI-based customization of notification content in cooperation with family and friend information, improvement of recipient reassurance, reduction of false positives, prompt response, and improvement of notification satisfaction—which were difficult with conventional uniform notifications or manual individualization—can be simultaneously achieved. Application fields include elderly monitoring, safety management for people living alone, abnormality response in care facilities, safety management in home medical care, and stress management support. With these configurations, the present invention not only automates human tasks but also realizes a fundamental advancement in computer technology through AI-based family/friend information-adaptive notification content customization.

The system according to the embodiment is not limited to the examples described above and can be variously modified as follows. Specifically, the system can flexibly change the types of AI models, data flows, hardware configurations, communication methods, sensor types, user interfaces, etc., in each unit such as voice data analysis, abnormality detection, notification, conversation, and customization. The system can utilize combinations of various AI architectures, including convolutional neural networks, recurrent neural networks, Transformer models, self-supervised learning models, and reinforcement learning models. The system can be configured as a multimodal AI system that integratively handles not only voice data but also image data, environmental sensor data, vital data, location information, activity history, home appliance control data, etc. The system can perform distributed processing on various hardware such as cloud servers, edge devices, local gateways, and smartphones. The system can flexibly select notification methods such as SMS, email, app notifications, voice calls, and IoT device integration. The system can automatically optimize AI model parameters, thresholds, notification content, conversation strategies, etc., according to user attributes and usage environments. The technical effect is that, by flexibly supporting various AI models, data, hardware, communication methods, and user interfaces, the system can simultaneously achieve scalability, adaptability, real-time capability, user satisfaction, reduction of false positives, and reduction of operational costs—which were difficult with conventional single configurations or static settings. Application fields include elderly monitoring, safety management for people living alone, abnormality monitoring in care facilities, safety management in home medical care, smart homes, IoT integration, remote medical care, industrial equipment monitoring, environmental monitoring, and stress management support. With these configurations, the present invention not only automates human tasks but also realizes the essential flexibility, scalability, and advancement of AI and computer technology.

The analysis unit can refer to the user's health status data during voice data analysis and adjust the analysis algorithm. For example, if the user has hypertension, the analysis of abnormal sounds is prioritized. If the user has diabetes, the analysis of abnormal sounds caused by hypoglycemia is prioritized. If the user has heart disease, the analysis of voice data for detecting abnormalities in heart rate is prioritized. By adjusting the analysis algorithm based on the user's health status, early detection of abnormalities can be achieved.

The notification unit can adjust the content of the notification based on the user's current activity status when an abnormality is detected. For example, if the user is exercising, a notification prompting the user to stop exercising is sent. If the user is sleeping, only notifications with high urgency are sent. If the user is working, the content of the notification is adjusted so as not to interfere with work. By adjusting the content of the notification based on the user's current activity status, appropriate responses can be promoted.

The collection unit can refer to the user's location information during voice data collection and adjust the collection method. For example, if the user is in the living room, voice data from the living room is preferentially collected. If the user is in the kitchen, voice data from the kitchen is preferentially collected. If the user is in the bedroom, voice data from the bedroom is preferentially collected. By adjusting the voice data collection method based on the user's location information, important voice data can be efficiently collected.

The analysis unit can refer to the user's lifestyle patterns during voice data analysis and optimize the analysis algorithm. For example, if the user wakes up at 7 a.m. every morning, the analysis of abnormal sounds at wake-up time is prioritized. If the user goes to bed at 10 p.m. every night, the analysis of abnormal sounds at bedtime is prioritized. If the user goes out every weekend, the analysis of abnormal sounds during outings is prioritized. By optimizing the analysis algorithm based on the user's lifestyle patterns, early detection of abnormalities can be achieved.

The notification unit can refer to the user's past abnormality detection history when an abnormality is detected and adjust the content of the notification. For example, if a scam call was detected in the past, a detailed notification is sent when a similar abnormality is detected. If a sound of an object falling was detected in the past, a notification prompting a prompt response is sent when a similar abnormality is detected. If a call for help was detected in the past, an emergency notification is sent when a similar abnormality is detected. By adjusting the content of the notification based on past abnormality detection history, appropriate responses can be promoted.

The collection unit can estimate a user's emotion and adjust the types of voice data to be collected based on the estimated emotion of the user. For example, if the user is feeling stressed, the collection of abnormal sounds is prioritized. If the user is relaxed, the collection of normal conversation sounds is prioritized. If the user is excited, the collection of high-frequency voice data is prioritized. By adjusting the types of voice data based on the user's emotion, important voice data can be efficiently collected.

The analysis unit can estimate a user's emotion and adjust the notification method of analysis results based on the estimated emotion of the user. For example, if the user is feeling anxious, detailed analysis results are notified. If the user is relaxed, concise analysis results are notified. If the user is excited, important analysis results are emphasized and notified. By adjusting the notification method of analysis results based on the user's emotion, appropriate information can be provided to the user.

The detection unit can estimate a user's emotion and adjust the frequency of abnormality detection based on the estimated emotion of the user. For example, if the user is feeling anxious, the frequency of abnormality detection is increased. If the user is relaxed, the frequency of abnormality detection is decreased. If the user is excited, the detection of important abnormalities is prioritized. By adjusting the frequency of abnormality detection based on the user's emotion, early detection of abnormalities and protection of privacy can be achieved.

The conversation unit can estimate a user's emotion and adjust the timing of conversation based on the estimated emotion of the user. For example, if the user is feeling anxious, conversation is started immediately. If the user is relaxed, the timing of conversation is delayed. If the user is excited, the timing of conversation is adjusted to calm the user. By adjusting the timing of conversation based on the user's emotion, appropriate conversation can be provided.

The notification unit can estimate a user's emotion and adjust the timing of notification transmission based on the estimated emotion of the user. For example, if the user is feeling anxious, notification is sent immediately. If the user is relaxed, the timing of notification transmission is delayed. If the user is excited, the timing of notification transmission is adjusted to calm the user. By adjusting the timing of notification transmission based on the user's emotion, appropriate information can be provided.

The following is a brief explanation of the processing flow of Example of the Embodiment.

Step 1: The collection unit collects voice data. For example, the collection unit constantly senses sounds in a room. The collection unit may also collect voice data using AI.

Step 2: The analysis unit analyzes the voice data collected by the collection unit. For example, the analysis unit analyzes the sensed voice data and detects abnormal sounds or conversations. The analysis unit analyzes voice data using AI.

Step 3: The detection unit detects an abnormality based on data analyzed by the analysis unit. For example, the detection unit detects an abnormality based on the analyzed data. The detection unit detects an abnormality using AI.

Step 4: The conversation unit attempts to converse with the user and confirm the situation when an abnormality is detected. For example, the conversation unit attempts to converse with the user and confirm the situation when an abnormality is detected. The conversation unit attempts to converse with the user using AI.

Step 5: The notification unit notifies a family of the abnormality confirmed by the conversation unit. For example, the notification unit notifies a family of the confirmed abnormality. The notification unit may also notify a family using AI.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the above-described collection unit, analysis unit, detection unit, conversation unit, and notification unit is implemented by at least one of, for example, a smart device 14 and a data processing apparatus 12. For example, the collection unit constantly senses sounds in a room using a microphone 38B of the smart device 14. The analysis unit is implemented by a specific processing unit 290 of the data processing apparatus 12 and analyzes the sensed voice data. The detection unit is implemented by the specific processing unit 290 of the data processing apparatus 12 and detects an abnormality based on the analyzed data. The conversation unit is implemented by a control unit 46A of the smart device 14 and attempts to converse with the user when an abnormality is detected. The notification unit is implemented by the specific processing unit 290 of the data processing apparatus 12 and notifies a family of the confirmed abnormality. The correspondence between each unit and the apparatus or control unit is not limited to the above examples and various modifications are possible.

### Second Embodiment

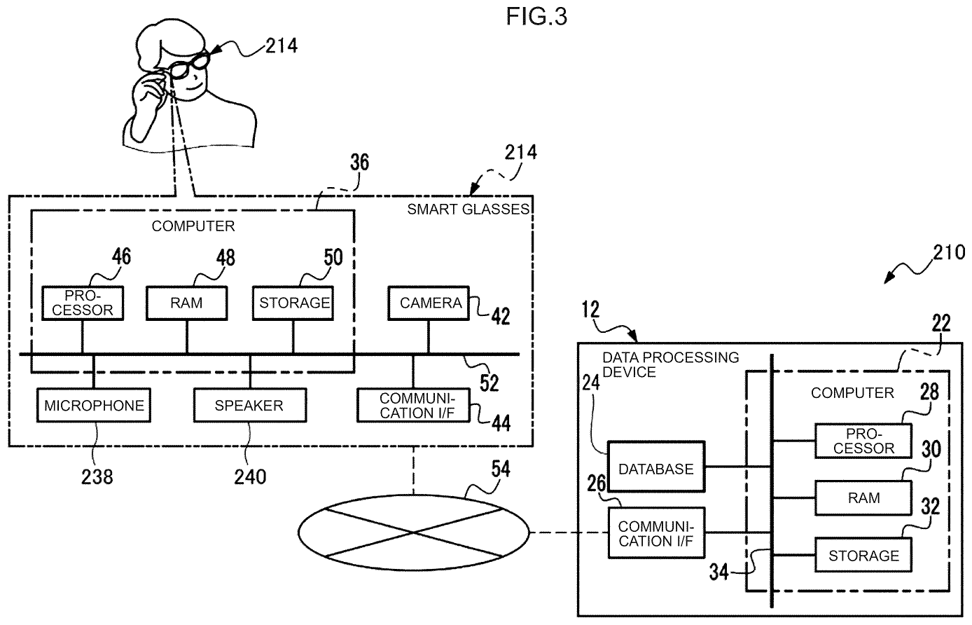

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

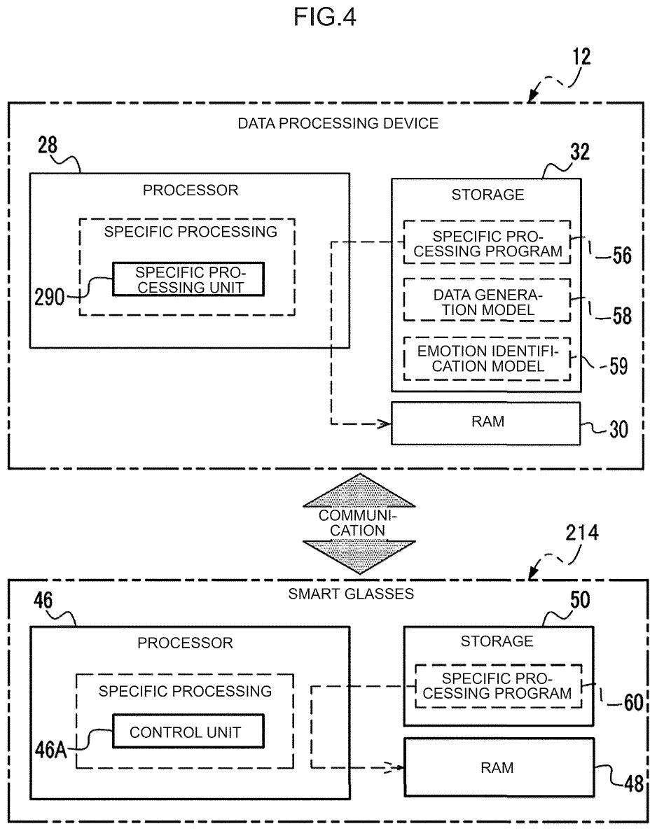

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the above-described collection unit, analysis unit, detection unit, conversation unit, and notification unit is implemented by at least one of, for example, smart glasses 214 and a data processing apparatus 12. For example, the collection unit constantly senses sounds in a room using a microphone 238 of the smart glasses 214. The analysis unit is implemented by a specific processing unit 290 of the data processing apparatus 12 and analyzes the sensed voice data. The detection unit is implemented by the specific processing unit 290 of the data processing apparatus 12 and detects an abnormality based on the analyzed data. The conversation unit is implemented by a control unit 46A of the smart glasses 214 and attempts to converse with the user when an abnormality is detected. The notification unit is implemented by the specific processing unit 290 of the data processing apparatus 12 and notifies a family of the confirmed abnormality. The correspondence between each unit and the apparatus or control unit is not limited to the above examples and various modifications are possible.

### Third Embodiment

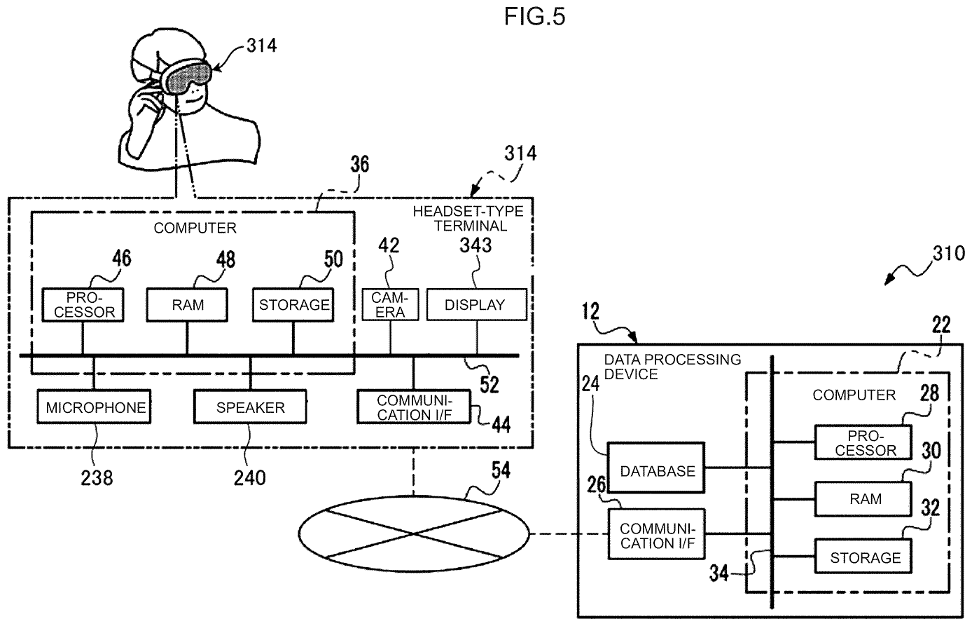

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

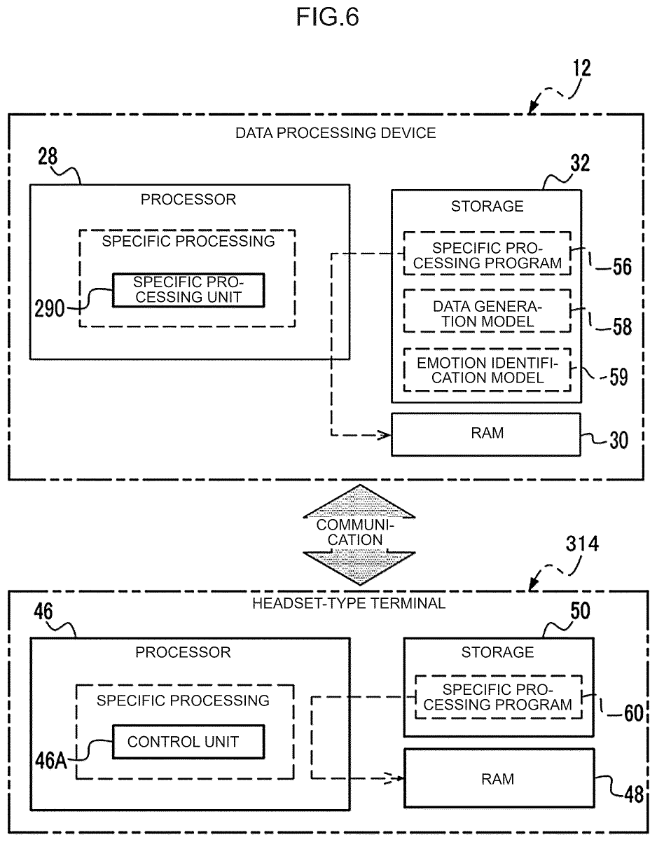

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the above-described collection unit, analysis unit, detection unit, conversation unit, and notification unit is implemented by at least one of, for example, a headset-type terminal 314 and a data processing apparatus 12. For example, the collection unit constantly senses sounds in a room using a microphone 238 of the headset-type terminal 314. The analysis unit is implemented by a specific processing unit 290 of the data processing apparatus 12 and analyzes the sensed voice data. The detection unit is implemented by the specific processing unit 290 of the data processing apparatus 12 and detects an abnormality based on the analyzed data. The conversation unit is implemented by a control unit 46A of the headset-type terminal 314 and attempts to converse with the user when an abnormality is detected. The notification unit is implemented by the specific processing unit 290 of the data processing apparatus 12 and notifies a family of the confirmed abnormality. The correspondence between each unit and the apparatus or control unit is not limited to the above examples and various modifications are possible.

### Fourth Embodiment

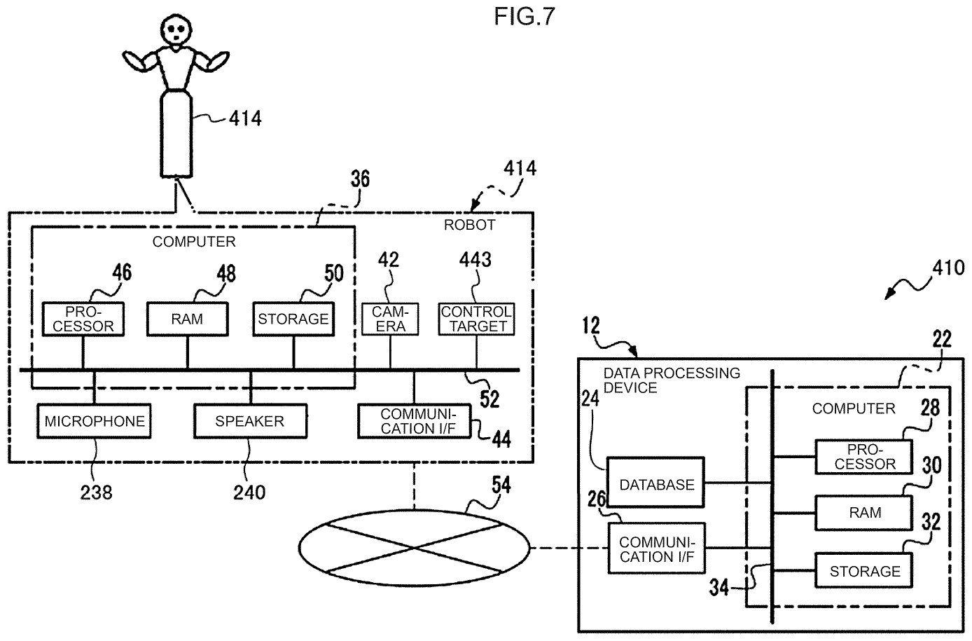

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

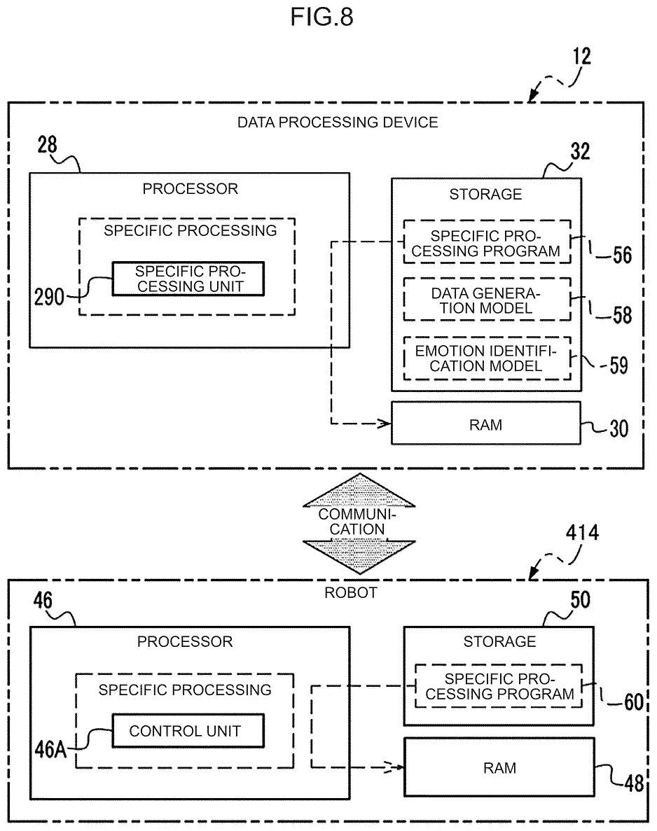

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the above-described collection unit, analysis unit, detection unit, conversation unit, and notification unit is implemented by at least one of, for example, a robot 414 and a data processing apparatus 12. For example, the collection unit constantly senses sounds in a room using a microphone 238 of the robot 414. The analysis unit is implemented by a specific processing unit 290 of the data processing apparatus 12 and analyzes the sensed voice data. The detection unit is implemented by the specific processing unit 290 of the data processing apparatus 12 and detects an abnormality based on the analyzed data. The conversation unit is implemented by a control unit 46A of the robot 414 and attempts to converse with the user when an abnormality is detected. The notification unit is implemented by the specific processing unit 290 of the data processing apparatus 12 and notifies a family of the confirmed abnormality. The correspondence between each unit and the apparatus or control unit is not limited to the above examples and various modifications are possible.

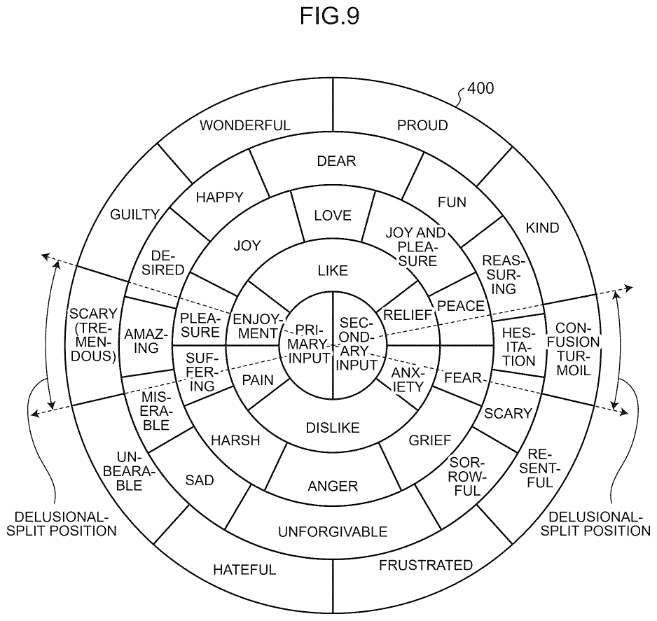

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

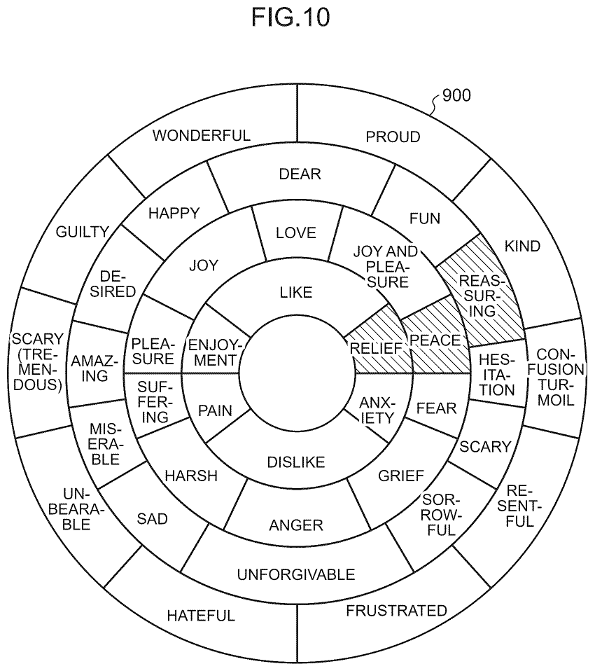

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

### (Supplementary Note 1)

A system comprising: a collection unit configured to collect voice data; an analysis unit configured to analyze the voice data collected by the collection unit; a detection unit configured to detect an abnormality based on data analyzed by the analysis unit; a conversation unit configured to converse with a user when an abnormality is detected by the detection unit; and a notification unit configured to notify a family of the abnormality confirmed by the conversation unit.

### (Supplementary Note 2)

The system according to Supplementary Note 1, wherein the collection unit is configured to constantly sense sounds in a room.

### (Supplementary Note 3)

The system according to Supplementary Note 1, wherein the analysis unit is configured to analyze the sensed voice data and detect abnormal sounds or conversations.

### (Supplementary Note 4)

The system according to Supplementary Note 1, wherein the detection unit is configured to detect an abnormality based on the analyzed data.

### (Supplementary Note 5)

The system according to Supplementary Note 1, wherein the conversation unit is configured to attempt to converse with the user and confirm the situation when an abnormality is detected.

### (Supplementary Note 6)

The system according to Supplementary Note 1, wherein the notification unit is configured to notify a family of the confirmed abnormality.

### (Supplementary Note 7)

The system according to Supplementary Note 1, wherein the detection unit includes a setting unit configured to set criteria for abnormality detection.

### (Supplementary Note 8)

The system according to Supplementary Note 1, wherein the notification unit includes a customization unit configured to customize the content of the notification.

### (Supplementary Note 9)

The system according to Supplementary Note 1, wherein the collection unit is configured to estimate a user's emotion and adjust the timing of collecting voice data based on the estimated emotion of the user.

### (Supplementary Note 10)

The system according to Supplementary Note 1, wherein the collection unit is configured to preferentially collect specific frequency bands when collecting sounds in a room.

### (Supplementary Note 11)

The system according to Supplementary Note 1, wherein the collection unit is configured to identify the direction of sounds during voice data collection and apply different collection methods for each direction.

### (Supplementary Note 12)

The system according to Supplementary Note 1, wherein the collection unit is configured to estimate a user's emotion and determine the priority of voice data to be collected based on the estimated emotion of the user.

### (Supplementary Note 13)

The system according to Supplementary Note 1, wherein the collection unit is configured to simultaneously collect environmental data of temperature and humidity in a room during voice data collection.

### (Supplementary Note 14)

The system according to Supplementary Note 1, wherein the collection unit is configured to refer to a user's activity history and adjust the collection method during voice data collection.

### (Supplementary Note 15)

The system according to Supplementary Note 1, wherein the analysis unit is configured to estimate a user's emotion and adjust the accuracy of analysis based on the estimated emotion of the user.

### (Supplementary Note 16)

The system according to Supplementary Note 1, wherein the analysis unit is configured to refer to past abnormal data and optimize the analysis algorithm during voice data analysis.

### (Supplementary Note 17)

The system according to Supplementary Note 1, wherein the analysis unit is configured to preferentially analyze specific voice patterns during voice data analysis.

### (Supplementary Note 18)

The system according to Supplementary Note 1, wherein the analysis unit is configured to estimate a user's emotion and adjust the display method of analysis results based on the estimated emotion of the user.

### (Supplementary Note 19)

The system according to Supplementary Note 1, wherein the analysis unit is configured to perform analysis based on environmental data in a room during voice data analysis.

### (Supplementary Note 20)

The system according to Supplementary Note 1, wherein the analysis unit is configured to refer to a user's past activity history and improve analysis accuracy during voice data analysis.

### (Supplementary Note 21)

The system according to Supplementary Note 1, wherein the detection unit is configured to estimate a user's emotion and adjust criteria for abnormality detection based on the estimated emotion of the user.

### (Supplementary Note 22)

The system according to Supplementary Note 1, wherein the detection unit is configured to refer to past abnormal data and optimize the detection algorithm when detecting an abnormality.

### (Supplementary Note 23)

The system according to Supplementary Note 1, wherein the detection unit is configured to preferentially detect specific abnormal patterns when detecting an abnormality.

### (Supplementary Note 24)

The system according to Supplementary Note 1, wherein the detection unit is configured to estimate a user's emotion and determine the priority of abnormality detection based on the estimated emotion of the user.

### (Supplementary Note 25)

The system according to Supplementary Note 1, wherein the detection unit is configured to perform detection based on environmental data in a room when detecting an abnormality.

### (Supplementary Note 26)

The system according to Supplementary Note 1, wherein the detection unit is configured to refer to a user's past activity history and improve detection accuracy when detecting an abnormality.

### (Supplementary Note 27)

The system according to Supplementary Note 1, wherein the conversation unit is configured to estimate a user's emotion and adjust the content of conversation based on the estimated emotion of the user.

### (Supplementary Note 28)

The system according to Supplementary Note 1, wherein the conversation unit is configured to refer to a user's past conversation history and select optimal conversation content when an abnormality is detected.

### (Supplementary Note 29)

The system according to Supplementary Note 1, wherein the conversation unit is configured to adjust the tone of conversation based on the user's current situation when an abnormality is detected.

### (Supplementary Note 30)

The system according to Supplementary Note 1, wherein the conversation unit is configured to estimate a user's emotion and determine the priority of conversation based on the estimated emotion of the user.

### (Supplementary Note 31)

The system according to Supplementary Note 1, wherein the conversation unit is configured to refer to information of the user's family or friends and customize conversation content when an abnormality is detected.

### (Supplementary Note 32)

The system according to Supplementary Note 1, wherein the conversation unit is configured to refer to a user's past activity history and improve the accuracy of conversation when an abnormality is detected.

### (Supplementary Note 33)

The system according to Supplementary Note 1, wherein the notification unit is configured to estimate a user's emotion and adjust the content of the notification based on the estimated emotion of the user.

### (Supplementary Note 34)

The system according to Supplementary Note 1, wherein the notification unit is configured to select a notification destination based on the user's past contact history when an abnormality is detected.

### (Supplementary Note 35)

The system according to Supplementary Note 1, wherein the notification unit is configured to adjust the notification transmission method based on the user's current situation when an abnormality is detected.

### (Supplementary Note 36)

The system according to Supplementary Note 1, wherein the notification unit is configured to estimate a user's emotion and determine the priority of notification based on the estimated emotion of the user.

### (Supplementary Note 37)

The system according to Supplementary Note 1, wherein the notification unit is configured to customize the content of the notification based on information of the user's family or friends when an abnormality is detected.

### (Supplementary Note 38)

The system according to Supplementary Note 1, wherein the notification unit is configured to adjust the notification transmission method based on the user's past activity history when an abnormality is detected.

### (Supplementary Note 39)

The system according to Supplementary Note 1, wherein the setting unit is configured to estimate a user's emotion and set criteria for abnormality detection based on the estimated emotion of the user.

### (Supplementary Note 40)

The system according to Supplementary Note 1, wherein the setting unit is configured to refer to past abnormal data and select optimal criteria when setting criteria for abnormality detection.

### (Supplementary Note 41)

The system according to Supplementary Note 1, wherein the setting unit is configured to estimate a user's emotion and customize criteria for abnormality detection based on the estimated emotion of the user.

### (Supplementary Note 42)

The system according to Supplementary Note 1, wherein the setting unit is configured to refer to information of the user's family or friends and adjust criteria when setting criteria for abnormality detection.

### (Supplementary Note 43)

The system according to Supplementary Note 1, wherein the customization unit is configured to estimate a user's emotion and customize the content of the notification based on the estimated emotion of the user.

### (Supplementary Note 44)

The system according to Supplementary Note 1, wherein the customization unit is configured to refer to past notification history and select optimal content when customizing the content of the notification.

### (Supplementary Note 45)

The system according to Supplementary Note 1, wherein the customization unit is configured to estimate a user's emotion and customize the priority of notification based on the estimated emotion of the user.

### (Supplementary Note 46)

The system according to Supplementary Note 1, wherein the customization unit is configured to refer to information of the user's family or friends and adjust the content when customizing the content of the notification.

What is claimed is:

1. A system comprising:
circuitry configured to:
receive, from a client terminal via a communication interface and a packet-switched network, audio data captured by a microphone of the client terminal;
extract, from the audio data, acoustic feature vectors comprising at least one of mel-frequency cepstral coefficients or spectrogram data;
analyze the acoustic feature vectors using a voice classification model comprising at least one of a convolutional neural network or a Transformer model to generate an abnormality score;
detect an abnormality based on the abnormality score exceeding a threshold;
generate, using a data generation model obtained by deep learning on a neural network, a conversation response to confirm a situation of a user when the abnormality is detected;
transmit the conversation response to the client terminal via the communication interface, the conversation response causing the client terminal to output the conversation response to the user;
receive, from the client terminal via the communication interface, response audio data representing a response from the user;
analyze the response audio data to determine an urgency level; and
transmit, when the urgency level exceeds an urgency threshold, a notification message to a remote terminal via the communication interface and the packet-switched network.

2. The system according to claim 1, wherein the audio data is continuously collected from the client terminal at a sampling rate of at least 16 kHz, and wherein the circuitry is configured to frame the audio data at regular intervals as one-dimensional tensors.

3. The system according to claim 1, wherein the abnormality comprises at least one of a fraudulent phone call pattern, a sound of an object falling, or a call for help, and wherein the voice classification model is trained to classify the audio data into abnormality labels comprising at least one of normal, crash, help, or scam_call.

4. The system according to claim 1, wherein the circuitry is further configured to extract, from the audio data, linguistic features by converting the audio data to text using a speech recognition model, and to analyze the linguistic features together with the acoustic feature vectors to generate the abnormality score.

5. The system according to claim 1, wherein the circuitry is further configured to estimate an emotion of the user by applying an emotion identification model to the audio data, and to adjust a frequency of receiving the audio data from the client terminal based on the estimated emotion, such that when the estimated emotion indicates stress, the frequency is increased.

6. The system according to claim 1, wherein the circuitry is further configured to preferentially extract acoustic feature vectors from specific frequency bands of the audio data, wherein the specific frequency bands comprise at least one of a frequency band associated with elderly voices or a frequency band associated with fraudulent phone calls.

7. The system according to claim 1, wherein the circuitry is further configured to identify a direction of a sound source in the audio data using beamforming with a microphone array, and to apply different analysis parameters based on the identified direction.

8. The system according to claim 1, wherein the circuitry is further configured to receive, from the client terminal via the communication interface, environmental sensor data comprising at least one of temperature data or humidity data, and to adjust the threshold for detecting the abnormality based on the environmental sensor data.

9. The system according to claim 1, wherein the circuitry is further configured to estimate an emotion of the user by applying an emotion identification model to the audio data, and to adjust analysis parameters of the voice classification model based on the estimated emotion, such that when the estimated emotion indicates anxiety, an abnormality detection threshold is lowered.

10. The system according to claim 1, wherein the circuitry is further configured to refer to past abnormality data stored in a database and to optimize parameters of the voice classification model based on the past abnormality data using supervised learning with a loss function comprising at least one of cross-entropy or focal loss.

11. The system according to claim 1, wherein the circuitry is further configured to preferentially analyze specific audio patterns in the audio data, the specific audio patterns comprising at least one of conversation phrases characteristic of fraudulent phone calls, impact sound spectra associated with objects falling, or acoustic features associated with calls for help.

12. The system according to claim 1, wherein the circuitry is further configured to estimate an emotion of the user by applying an emotion identification model to the response audio data, and to adjust a content of the conversation response based on the estimated emotion, such that when the estimated emotion indicates anxiety, the conversation response comprises reassuring content.

13. The system according to claim 1, wherein the circuitry is further configured to refer to a past conversation history associated with the user and to select the conversation response based on the past conversation history.

14. The system according to claim 1, wherein the circuitry is further configured to adjust a tone of the conversation response based on a current situation of the user, such that when the user is anxious, the conversation response is generated in a calm tone, and when the user is relaxed, the conversation response is generated in a bright tone.

15. The system according to claim 1, wherein the circuitry is further configured to select, from a plurality of remote terminals, a notification destination based on a past contact history associated with the user.

16. The system according to claim 1, wherein the circuitry is further configured to adjust a notification method based on a current activity status of the user received from the client terminal, the notification method comprising at least one of a push notification, an SMS message, or an email notification.

17. The system according to claim 1, wherein the circuitry is further configured to customize a content of the notification message based on recipient attributes associated with the remote terminal, the recipient attributes comprising at least one of age or relationship to the user.

18. A system comprising:
a communication interface configured to communicate, via a packet-switched network conforming to at least one of a 5G, Wi-Fi, or Bluetooth communication standard, with a client terminal comprising a microphone having a CMOS acoustic sensor, a speaker, and a display;
a processor;
a random-access memory;
a memory storing a data generation model obtained by deep learning on a neural network, and an emotion identification model;
a database; and
circuitry configured to:
receive, from the client terminal via the communication interface, audio data captured by the microphone at a sampling rate of at least 16 kHz;
extract, from the audio data, acoustic feature vectors comprising mel-frequency cepstral coefficients and spectrogram data of at least 128 dimensions;
analyze the acoustic feature vectors using a voice classification model comprising a convolutional neural network and a Transformer model with a self-attention mechanism to generate an abnormality score in a range of 0.0 to 1.0;
detect an abnormality based on the abnormality score exceeding a predetermined threshold;
estimate an emotion of a user by applying the emotion identification model to the audio data;
generate, using the data generation model, a conversation response adapted based on the estimated emotion;
transmit the conversation response to the client terminal via the communication interface, the conversation response causing the client terminal to output the conversation response via at least one of the speaker or the display;
receive, from the client terminal via the communication interface, response audio data and analyze the response audio data to determine an urgency level and an emotion label; and
transmit, when the urgency level exceeds an urgency threshold, a notification message to a remote terminal via the communication interface, the notification message comprising at least a type of the abnormality, an occurrence time, and an estimated user situation.

19. The system according to claim 18, wherein the data generation model comprises at least one of a text generation AI, an image generation AI, or a multimodal generation AI, and wherein the data generation model is a fine-tuned model configured to output inference results from prompts without instructions.

20. A method performed by circuitry of a system comprising a communication interface, a memory storing a data generation model obtained by deep learning on a neural network, and circuitry, the method comprising:
receiving, from a client terminal via the communication interface and a packet-switched network, audio data captured by a microphone of the client terminal;
extracting, from the audio data, acoustic feature vectors comprising at least one of mel-frequency cepstral coefficients or spectrogram data;
analyzing the acoustic feature vectors using a voice classification model comprising at least one of a convolutional neural network or a Transformer model to generate an abnormality score;
detecting an abnormality based on the abnormality score exceeding a threshold;
generating, using the data generation model, a conversation response to confirm a situation of a user when the abnormality is detected;
transmitting the conversation response to the client terminal via the communication interface;
receiving, from the client terminal via the communication interface, response audio data representing a response from the user;
analyzing the response audio data to determine an urgency level; and
transmitting, when the urgency level exceeds an urgency threshold, a notification message to a remote terminal via the communication interface and the packet-switched network.
